(19) United States
(12) Patent Application Publication
(10) Pub. No.: US 2023/0349585 A1
(43) Pub. Date: Nov. 2, 2023

(54) ELLIPTICAL DUCTING SYSTEMS AND REINFORCED CONNECTORS

(71) Applicant: Jeffrey A. Hermanson, Algona, WA (US)

(72) Inventor: Jeffrey A. Hermanson, Algona, WA (US)

(21) Appl. No.: 17/995,048

(22) PCT Filed: Mar. 26, 2021
(86) PCT No.: PCT/US2021/024392

§ 371 Date: Sep. 29, 2022

Related U.S. Application Data
(60) Provisional application No. 63/001,988, filed on Mar. 30, 2020.

(51) Int. Cl. F24F 13/02; F16L 23/032; F16L 23/12; F16L 9/00; F16L 59/14; F16L 43/00

(52) U.S. Cl. CPC F24F 13/0209; F16L 23/032; F16L 23/12; F16L 9/006; F16L 59/143; F16L 43/00; F16L 41/02

(57) ABSTRACT

A ducting system includes an elongate duct section or length and formed flange connectors at each end of the duct. Both the duct section and the flange connectors are elliptical in cross section, defined by a major axis and a minor axis. The elliptical cross section has the advantage of reducing the overall height of the duct system along minor axis, as well as defining a rigid structure due to there being no flat surface about the circumference of the duct, while also capable of transporting a significant volume of air relative to a circular duct system of the same size perimeter.

### CROSS-REFERENCE TO RELATED APPLICATION

This application claims the benefit of U.S. Provisional Application No. 63/001,988, filed Mar. 30, 2020, the disclosure of which is incorporated herein by reference in its entirety.

### FIELD OF THE INVENTION

The present invention relates to HVAC ducting systems, and in particular HVAC ducting systems having an elliptical cross-sectional shape for ducts, for reinforced connectors used to connect the elliptical ducts, as well as reinforced connectors for connecting ducts of other cross-sectional shapes and for associated fittings for these ducting systems as well as for connectors that are reinforced for improved strength.

### BACKGROUND

HVAC ducting is currently available in various cross-sectional shapes, including circular, square, and rectangular. Ducting is also available in what is termed “flat oval,” consisting of a rectangular cross-section wherein the ends of rectangle are semicircular or otherwise rounded. Rectangular and flat oval ducting is advantageous in situations where the vertical height of the ducting needs to be constrained. However, a drawback of rectangular and flat oval ducting is that the sidewalls of the ducting are flat and thus are prone to bulge under pressure or vibrate during airflow unless reinforced or otherwise constrained.

Regardless of the cross-sectional shape of the ducting, the ducting must be interconnected, for example, end to end. One type of connection is in the form of flanged rings or frames, which are attached to the ends of the duct sections and present a mating flange extending transversely to the length of the duct, extending laterally or radially from the exterior of the duct. Such rings are not just round in shape, but match the cross-sectional shape of the duct, which as noted above, can also be in the shape of, for example, a flat oval, a square or a rectangle, etc. The two mating flanges of adjacent flanged ring connectors may be attached together in face-to-face relationship by screws, bolts, or other hardware members extending through the flanged rings. Another attachment method is to use clips or a closure band that entirely or partially encircles the exterior perimeter of the face-to-face mating flanges of adjacent flanged rings.

Not uncommonly, especially in larger size HVAC ducting, the flanged rings are often not sufficiently stiff to create a satisfactory joint between HVAC duct sections or with fittings. The flanged rings can be constructed from thicker gauge material, but doing so increases the cost of the flanged rings and also increases the weight of the flanged rings. In addition, the flanged rings are more difficult to form with thicker gauge material. As such, efforts have been made to produce flanged rings with exterior hems and returns to increase the section modulus of the flanged rings. However, other alternatives for reinforcing or increasing the strength or rigidity of the flanged rings are desirable.

### SUMMARY

In accordance with one embodiment of the present disclosure, an HVAC duct system includes an elongate duct consisting of a metallic substrate formed into an elliptical cross-sectional shape having an aspect ratio of from 1:1.1 to 1:4.

In any of the embodiments disclosed herein, wherein flange connectors are formed on one or both ends of the duct, wherein the flange connectors have mating flange portions extending transversely to the length of the duct, the flange connectors having an elliptical cross-sectional shape corresponding to the cross-sectional shape of the duct.

In any of the embodiments disclosed herein, wherein the mating flange portions comprising an outer perimeter, and a formed reinforcing seat extending along the outer perimeter of the mating flange portions, the reinforcing seat projecting laterally from the plane of the mating flange in the direction toward the opposite end of the HVAC ducting.

In any of the embodiments disclosed herein, wherein the reinforcing seat is of a cross-sectional shape selected from the group consisting of: square, polygonal, oblong, rectangular, circular, partially circular, quarter-circular, semicircular, elliptical, oval, triangular, frusto-triangular, vee-shaped, arcuate, and tubular.

In any of the embodiments disclosed herein, wherein the reinforcing seat projecting laterally from the mating flange face a distance in the range of ¼ to 3 inches.

In any of the embodiments disclosed herein, further comprising a reinforcing member tightly disposed within the reinforcing seat.

In any of the embodiments disclosed herein, wherein the reinforcing member is shaped to corresponds to the shape of the reinforcing seat.

In any of the embodiments disclosed herein, wherein the cross-sectional shape of the reinforcing member matches the shape of the reinforcing seat.

In any of the embodiments disclosed herein, wherein the reinforcing member is of a shape selected from the group consisting of solid, tubular, hollow, partially hollow, arcuate, triangular, and right angular.

In any of the embodiments disclosed herein, further comprising a closure band extending around the outer perimeter of flange connectors at adjacent ends of HVAC ducting for retaining the flange connectors in face-to-face relationship to each other.

In any of the embodiments disclosed herein, wherein the closure band at least partially encircles the reinforcing seat of the flange connectors to capture the reinforcing seats.

In any of the embodiments disclosed herein, wherein the closure band includes a seal member for sealing the outer perimeters of the flange connectors against leakage from the HVAC ducting.

In any of the embodiments disclosed herein, wherein the closure band is configured to capture the seal member so that when the closure band is installed, the seal member seals the outer perimeter portions of adjacent flange connectors.

In any of the embodiments disclosed herein, wherein the closure band further comprising end tabs for hooking over a portion of the reinforcing seat to assist in maintaining the closure band engaged with the reinforcing seats.

In any of the embodiments disclosed herein, further comprising one or more fittings for connection to the elliptical cross-sectional duct selected from the group consisting of: elbows; taps; lateral taps; angle taps; boot taps; T-fittings; reducers; dampers; slip connectors; offset connectors.

In any of the embodiments disclosed herein, wherein the mating flange portion comprising a first section extending transversely outwardly from the end of the duct and the second section doubled over the first section to extend transversely outwardly toward the duct to form a mating face to the pledge connector of an adjacent duct.

In any of the embodiments disclosed herein, where in the second section of the mating flange portion defining an inner perimeter; and further comprising a return section extending from the inner perimeter of the second section of the mating flange toward the duct.

In any of the embodiments disclosed herein, wherein the return section extending along the inside surface of the duct.

In any of the embodiments disclosed herein, wherein the return section closely overlying the inside surface of the duct.

In any of the embodiments disclosed herein, wherein the substrate is composed of spiral lock seam ducting, longitudinal lock seam ducting or longitudinal welded seam ducting.

In accordance with one embodiment of the present disclosure, a flange ring connector to join ducts in an HVAC system, wherein the ducts are elliptical in cross section, the flanged ring connector, including:
(a) a mating flange defining a mating face, the mating flange defining an outer perimeter portion and an inner perimeter portion, and the mating flange being of an elliptical shape corresponding to the elliptical cross-sectional shape of the HVAC ducts;
(b) an insertion flange extending laterally from the inner perimeter portion of the mating flange, the insertion flange having an inside surface and an outside surface, the insertion flange in cross-section closely corresponding to the elliptical cross-sectional shape of the HVAC ducts, and the insertion flange having a sufficient length to allow fixed attachment to the elliptically-shaped HVAC ducting; and
(c) a formed reinforcing seat extending around the perimeter of the mating flange and projecting laterally from the mating flange in the direction that the insertion flange extends from the mating flange.

In any of the embodiments disclosed herein, wherein the reinforcing seat is of a cross-sectional shape selected from the group consisting of square, polygonal, oblong, rectangular, circular, partially circular, quarter-circular, semicircular, elliptical, oval, triangular, frusto-triangular, vee-shaped, arcuate, and tubular.

In any of the embodiments disclosed herein, wherein the cross-sectional size of the reinforcement seat may vary in size in accordance with the desired increase in structural integrity of the flanged ring connector.

In any of the embodiments disclosed herein, wherein the reinforcement seat extends from 0.75 inch to at least 2 inches radially outwardly from the insertion flange.

In any of the embodiments disclosed herein, wherein the mating and insertion flanges comprise an angle ring configuration.

In any of the embodiments disclosed herein, further comprising a reinforcing member disposed within the reinforcing seat to increase the structural integrity of the flanged ring connector.

In any of the embodiments disclosed herein, wherein the reinforcing member is shaped to corresponds to the shape of the reinforcing seat.

In any of the embodiments disclosed herein, wherein the reinforcing member is of a shape selected from the group consisting of solid, tubular, hollow, arcuate, triangular, and right angular.

In any of the embodiments disclosed herein, further comprising a closure band extending around the outer perimeter of flange connectors at adjacent ends of HVAC ducting for retaining the flange connectors in face-to-face relationship to each other.

In any of the embodiments disclosed herein, wherein the closure band at least partially encircles the reinforcing seat of the flange connectors to capture the reinforcing seats.

In any of the embodiments disclosed herein, wherein the closure band includes a seal member for sealing the outer perimeters of the flange connectors against leakage from the HVAC ducting.

In accordance with one embodiment of the present disclosure, a flange ring connector to join ducts in an HVAC system, including:
(a) a mating flange defining a mating face, the mating flange defining an outer perimeter portion and an inner perimeter portion, and the mating flange being of a shape corresponding to the cross-sectional shape of the HVAC ducting;
(b) an insertion flange extending laterally from the inner perimeter portion of the mating flange, the insertion flange having an inside surface and an outside surface, the insertion flange in cross-section closely corresponding to the cross-sectional shape of the HVAC ducts, and the insertion flange having a sufficient length to allow fixed attachment to the HVAC ducts; and
(c) a formed reinforcing seat extending around and integrally formed with the perimeter of the mating flange, the reinforcing seat projecting laterally from the outer perimeter portion of the mating flange in the direction that the insertion flange extends from the mating flange and then projecting in the direction towards the insertion flange.

In any of the embodiments disclosed herein, wherein the mating and insertion flanges comprise an angle ring configuration.

In any of the embodiments disclosed herein, wherein the reinforcing seat is of a cross-sectional shape selected from the group consisting of square, polygonal, oblong, rectangular, circular, partially circular, quarter-circular, semicircular, elliptical, oval, triangular, frusto-triangular, vee-shaped, arcuate, and tubular.

In any of the embodiments disclosed herein, further comprising a reinforcing member disposed within the reinforcing seat to increase the structural integrity of the flanged ring connector.

In any of the embodiments disclosed herein, wherein the reinforcing member is shaped to corresponds to the shape of the reinforcing seat.

In any of the embodiments disclosed herein, wherein the reinforcing member is of a shape selected from the group consisting of solid, tubular, hollow, arcuate, triangular, and right angular.

In any of the embodiments disclosed herein, further comprising a closure band extending around the outer perimeter of flange connectors at adjacent ends of HVAC ducting for retaining the flange connectors in face-to-face relationship to each other.

In any of the embodiments disclosed herein, wherein the closure band includes a seal member for sealing the outer perimeters of the flange connectors against leakage from the HVAC ducting.

In accordance with one embodiment of the present disclosure, an architectural feature of an elliptical cross-sectional shape constructed by forming flat stock into an elliptical cross-section with the edges of the flat stock in close side-by-side relationship to each other to define a seam and by closing the seam.

In any of the embodiments disclosed herein, wherein the seam is closed by welding.

In any of the embodiments disclosed herein, wherein the architectural feature is selected from the group consisting of railings, hanging rods, hanging bars, brackets, stanchions, and legs.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial view of an HVAC duct system in accordance with the present disclosure having an elliptical cross section;

FIG. 2 is an isometric view of flanged ring connectors for interconnecting adjacent ends of HVAC ducting wherein the flanged ring connectors are constructed with an outer perimeter in the form of a reinforced reverse curl;

FIGS. 3A, 3B, and 3C are cross-sectional views of FIG. 1;

FIGS. 4, 5, 6, 7, and 8 are cross-sectional views of reinforced flanged ring connectors with the outer perimeter portions formed into a reverse reinforcement configuration;

FIGS. 9, 10, 11, 12, 13, and 14 illustrate in partial cross section various configurations of flanged ring connectors corresponding to the present disclosure shown in face-to-face relationship to each other, wherein the outer perimeter of the flange face is of a reverse-formed reinforced configuration;

FIG. 15 illustrates an example of a closure band used with the flanged ring connectors of FIG. 16,

FIG. 17 illustrates another example of a closure band used with the flanged ring connectors of FIG. 18;

FIGS. 19, 20, and 21 illustrate other examples of closure bands of the present disclosure;

FIGS. 22A, 22B, and 22C illustrate the relationship between a circle and the corresponding elliptical shapes of the same perimeter length as the circle;

FIGS. 23A and 23B schematically illustrate an example of a method of forming an HVAC duct in elliptical cross-section;

FIGS. 24A and 24B illustrate one manner of forming the flanged ring connector of FIGS. 3A-3C as well as FIGS. 4 and 5;

FIGS. 25A and 25B illustrate one manner of forming the flanged ring connector of FIG. 7;

FIGS. 26A and 26B illustrate one manner of forming the flanged ring connector of FIG. 6;

FIGS. 27A, 27B, 27C, and 27D illustrate one manner of forming the flanged ring connector of FIG. 8;

FIGS. 28A and 28B illustrate one manner of forming the flanged ring connector of FIGS. 3A, 3B, and 3C into an elliptical shape;

FIGS. 29A and 29B illustrate a 90-degree elbow having an elliptical cross-sectional shape of the present disclosure:

FIGS. 30A and 30B illustrate a 60-degree elbow having an elliptical cross-sectional shape of the present disclosure;

FIGS. 31A and 31B illustrate a 45-degree elbow of an elliptical cross-sectional shape of the present disclosure;

FIGS. 32A and 32B illustrate a mitered 90-degree elbow having an elliptical cross-sectional shape of the present disclosure;

FIGS. 33A and 33B illustrate a lateral angle tap having an elliptical cross-sectional shape of the present disclosure;

FIGS. 34A and 34B illustrate a 45-degree lateral fitting having an elliptical cross-sectional shape of the present disclosure;

FIGS. 35A and 35B illustrate a Tee fitting having an elliptical cross-sectional shape of the present disclosure;

FIGS. 36A and 36B illustrate a concentric reducer fitting having an elliptical cross-sectional shape of the present disclosure;

FIGS. 37A and 37B illustrate a damper having an elliptical cross-sectional shape of the present disclosure;

FIGS. 38A and 38B illustrate an offset fitting;

FIGS. 39A and 39B illustrate a boot tap cross fitting;

FIG. 40 illustrates a slip joint for interconnecting HVAC ducting of an elliptical cross-section;

FIGS. 41-45 illustrate another connector flange system according to the present disclosure;

FIGS. 46 and 47 illustrate another ducting system on the present disclosure;

FIG. 40 illustrates a flange connector of the present disclosure;

FIGS. 49 A-49 B illustrate a representative manner of forming the flange connector of FIG. 40;

FIGS. 50A-50 C illustrate another representative method of forming the flange connector of FIG. 40;

FIG. 51 illustrates a double wall elliptical ducting system of the present disclosure;

FIGS. 52-60 illustrate alternative embodiments of double wall flange connectors for interconnecting elliptical ducting; and

FIGS. 61 and 62 illustrate an angle ring connector in accordance with the present disclosure.

### DETAILED DESCRIPTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “horizontal,” “vertical,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions.

The present application may include modifiers such as the words “generally,” “approximately,” “about,” or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

In the following description and in the accompanying drawings, corresponding systems, assemblies, apparatus and units may be identified by the same part number, but with an alpha suffix. The descriptions of the parts/components of such systems assemblies, apparatus, and units that are the same or similar are not repeated so as to avoid redundancy in the present application.

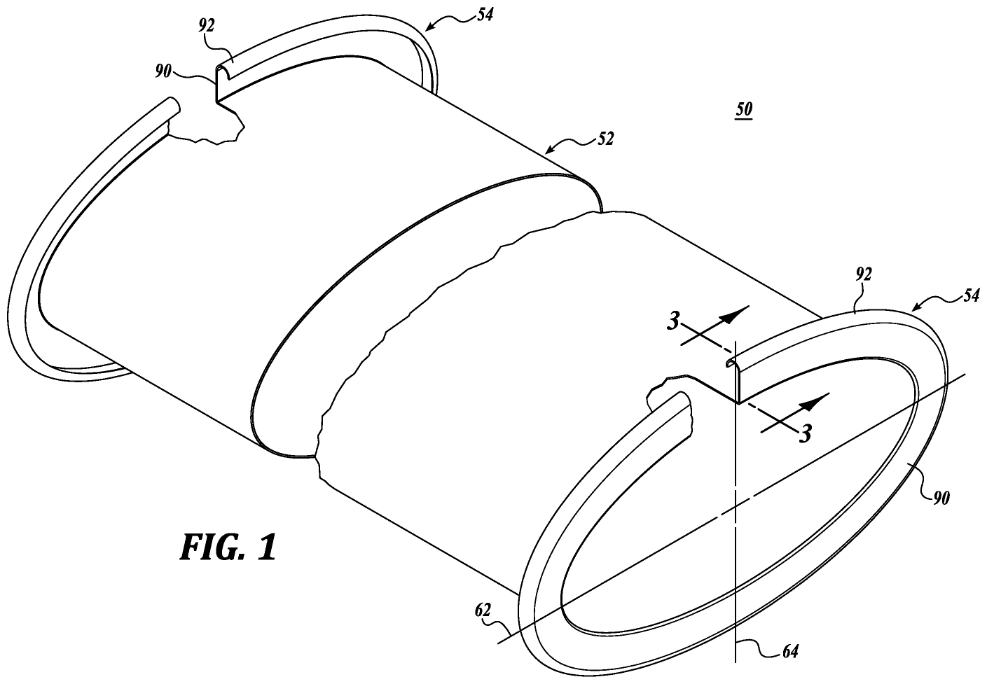

FIG. 1 discloses ducting system 50 in accordance with one embodiment of the present disclosure. The ducting system 50 includes an elongate duct section or length 52 and formed flange connectors 54 at each end of the duct. Both the duct section 52 and the flange connectors 54 are elliptical in cross section, defined by a major axis 62 and a minor axis 64. The elliptical cross section has the advantage of reducing the overall height of the duct system along minor axis 64, as well as defining a rigid structure due to there being no flat surface about the circumference of the duct 52, while also capable of transporting a significant volume of air relative to a circular duct system of the same size perimeter. In this regard, applicant considers the transportation of a significant volume of air to be at least about 75% of the capacity of a circular duct system.

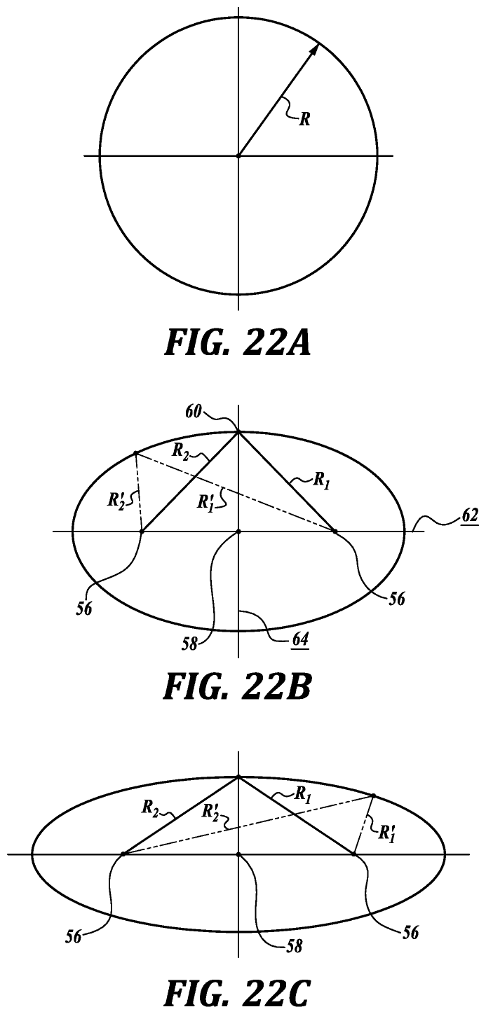

In particular, the aspect ratio (height to width) of the duct 52 can vary so as to meet specific height restrictions for the duct. FIGS. 22B and 22C provide examples of elliptical ducts of different aspect ratios, but with the same perimeter as a corresponding circular duct shown in FIG. 22A. As illustrated in FIGS. 22A, 22B, and 22C, the radius R of FIG. 22A corresponds to the radii R1 and R2 in FIGS. 22B and 22C. The difference among the three figures is that locations of the focal/foci points 56. Ellipses are defined as having two focal points spaced apart along the major axis of the ellipse. In FIG. 22A, the focal point of the radius R is at the center of the circle. In FIGS. 22B and 22C the foci points are spaced from the center of the ellipse, along major axis 62. The distance of the foci points from center of the ellipse 58 is greater in FIG. 22C than in FIG. 22B, thereby increasing the aspect ratio of the ellipse in FIG. 22C relative to 22B.

As will be appreciated, the perimeter of the ellipsis shown in FIGS. 22B and 22C can be created by rotating the lengths R1 and R2 about their focal points while the sum of R1 and R2 remains constant (equaling 2×R shown in FIG. 22A). As can be shown in FIG. 22C versus FIG. 22B, the focal points are even further away from the center 58, the aspect ratio of the ellipse become greater, causing the overall height of the ellipse to be reduced while the width of the ellipse is increased. Compare FIG. 22C versus 22B.

The present disclosure contemplates that the aspect ratio of duct 52 can vary through a wide range, for example, from an aspect ratio of about 1:1.1 to an aspect ratio of about 1:4. The specific aspect ratio can depend on various factors, including the maximum vertical clearance available for the ducting, as well as the required flow capability of the ducting. For example, with an aspect ratio of 1:1.5, the cross-sectional area of the ellipse is approximately 94% of a circular duct having the same perimeter. If the aspect ratio is increased to 1:2, the cross-sectional area of the ellipse is approximately 84% of the cross-sectional area of a circular duct having the same perimeter. Thus, even at an aspect ratio of 1:2, the reduction in cross-sectional area between a circular duct and an elliptical duct of the same perimeter is only decreased by about 16%. Of course, an increase in the cross-sectional area of the elliptically-shaped duct can be achieved by increasing the perimeter of the duct so that the length of the major axis of the duct is increased while maintaining the length of the minor axis (height) of the duct.

HVAC ducting using an elliptical cross-section in accordance with the present disclosure can vary greatly in size from ducts wherein the corresponding circular duct radius is from, for example, 6 inches to 60 inches, for example. Also, the elliptical ducting can be constructed from different material gauges in the same manner as circular ducting. For example, such material thickness may range from 0.030 inch to 0.125 inch and thicker.

In addition to being able to meet height restrictions for ducting, one advantage of an elliptical-shaped duct versus, for example, a rectangular-shaped duct, is that the entire perimeter of an elliptical-shaped duct is curved, whereas in a rectangularly-shaped duct, the entire top and bottom surface of the duct is flat. As such, in a rectangularly-shaped duct, the top and bottom surfaces can deform outwardly under a positive pressure or inwardly under a negative pressure, if not reinforced or braced. As such, bracing is required in rectangularly-shaped ducting to retain the shape of the ducting.

Further, the bending modulus of an elliptical-shaped duct about the cross-sectional major axis of the duct is higher than the bending modulus of a comparable rectangularly-shaped duct, which results in less defection along the length of the duct. As such, the hangers for an elliptically-shaped duct can be spaced further apart than for a comparable rectangularly-shaped duct.

Some of the same advantages of an elliptically-shaped duct also may apply to a flat oval duct profile. Such a duct profile resembles a rectangularly-shaped duct, but with the minor ends of the duct being rounded. Nonetheless, a major portion of the upper and lower surfaces of this duct configuration is flat, as in a rectangularly-shaped duct. This flatness leads to the same disadvantages of rectangularly-shaped ducting discussed above.

The ducting 52 can be of various constructions, for example, the ducting can be composed of a spiral lock seam substrate, a longitudinal lock seam substrate, a longitudinal welded seam substrate, etc.

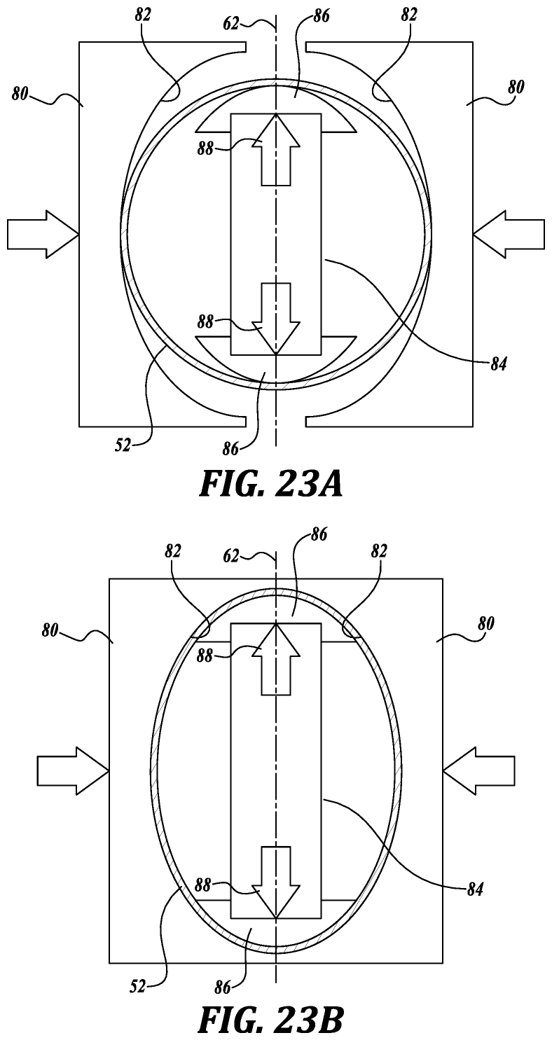

The elliptical shape of the ducting system 50 can be achieved by various methods. One method is shown in FIGS. 23A and 23B, wherein die halves 80 press against the sides of the ducting, which is originally circular in shape, to cause the circularly-shaped ducting to assume an elliptical shape corresponding to the inside surfaces 82 of the dies 80. Simultaneously, optionally an expander system 84 can be used to press against the diametrically-opposite interior portions of the ducting 52 along the major axis 62 of the duct. The coordinated action of the exterior pressing dies 80 and the interior expanding die 84 causes the initially round-shaped duct 52 to assume a desired elliptical shape. During this transition from circular to elliptical, the duct is stretched by a small percentage, which has the advantage of causing the duct to retain the desired elliptical shape defined by the interior surface 82 of the pressing dies 80 and the curved heads 86 of the expansion die 84. Such curved heads 86 can be forced against the interior surface of the duct 52 by, for example, hydraulic actuators, which are symbolized by arrows 88.

It will be appreciated that the pressing dies 82 may be configured to accommodate the shape of the flange connectors 54 at the ends of the duct 52. Alternatively, auxiliary pressing dies, not shown, can be attached to the pressing dies 80, with such auxiliary pressing dies corresponding to the shape of the flange connectors 54.

Instead of using both pressing dies 80 and an interior expanding die 84, duct 52 can be manufactured by using just the pressing die 80 or just the expanding die 84. Further, the duct 52 could be constructed by using the pressing dies 80 and a different system for expanding or shaping the interior of the duct. Correspondingly the duct 52 could be constructed by using an interior expanding die 84 in conjunction with a different type of exterior system for helping shape the exterior of the duct 52 into an elliptical form.

Further, in place of expanding die 84, other means can be used to create an elliptical-shaped duct from a round shape. For example, an air bladder or airbag can be placed within the circular duct, which in turn is located within an exterior die, similar to that of die 80, but such die is not designed to press against the duct 52 as it is being formed from round to elliptical shape as the air bladder within the circular duct is expanded. With such expansion the exterior of the originally circular duct 52 assumes the shape defined by the interior surfaces 82 of the dies 80, and at the same time the dies 80 are moved inwardly to the position shown in FIG. 23B. The difference in this manufacturing procedure is that the dies 80 do not have to be powered to the level needed to press against the exterior of the initially round duct 52 to change its shape into an ellipse. Rather, the dies 80 only need to be powered so as to close as the duct 52 is being change from circular to elliptical shape by the expanding air bladder or airbag.

As a further technique for producing an elliptical-shaped duct structure, the ends of a length of round ducting (whether in the form of spiral ducting, or ducting with a longitudinal seam, etc.) can be attached to elliptical-shaped flange connectors, whereupon the round ducting in cross-section will assume the shape of the elliptical flange-shaped connectors which have been attached to the ends thereof. As such, neither pressing dies, expanding dies or other means are needed to change the shape of the ducting from round to elliptical.

In addition to HVAC ducting formed from steel, the present invention may be applied to other ducting composed of other materials. For example, the present invention may apply to ducting composed of fiberglass, a polymer such as a thermoplastic, or a thermoplastic reinforced with fiberglass or carbon fibers. Such ducting is commonly used in clean rooms and other sterile environments. Such elliptically-shaped fiberglass or thermoplastic ducting can be constructed by injection molding or by extruding the ducting directly as an elliptical cross-sectional shape. Injection molding may also be used to manufacture fittings for the fiberglass/thermoplastic ducting, which fittings are described below.

In another aspect of the present disclosure, ducting in elliptical cross-section can be composed of a cloth sock or exterior to place over an internal framework of metal, fiberglass, thermoplastic, or other material. The sock is pervious to air so that air being transmitted through the sock is capable of passing outwardly through the sock material to provide the required heating, cooling, and ventilation functions. The internal framework can be composed of wire sheet material or similar material that has been formed into an elliptical shape by, for example, rolling the wire sheet material over an elliptical die.

A further aspect of the present invention includes forming architectural materials or features as well as other materials or features in an elliptical cross-sectional shape, for example, railings for stairs, balconies, decks, and other installations. Such railings could be composed of virtually any desirable metallic material. In one example, the elliptical cross-section can be achieved by rolling a flat band of the metallic material into an elliptical cross-section and then welding the longitudinal seam extending along the length of the formed railing. It can be appreciated that such elliptical cross-sectionally-shaped lengths can be used for many other purposes in addition to serving as railings. For example, rods or bars for hanging fabrics such as curtains, drapes, fabrics or towels, as well as mounting brackets therefor. Other purposes can include stanchions or legs for railings or bannisters. The elliptical cross-sectional shape is not only visually appealing, but also of significant structural strength. Moreover, this process of manufacturing architectural materials can also be used to manufacture HVAC ducting, including ducting of large cross-sections, for example having a radius R1 or R2 of 60 inches or more.

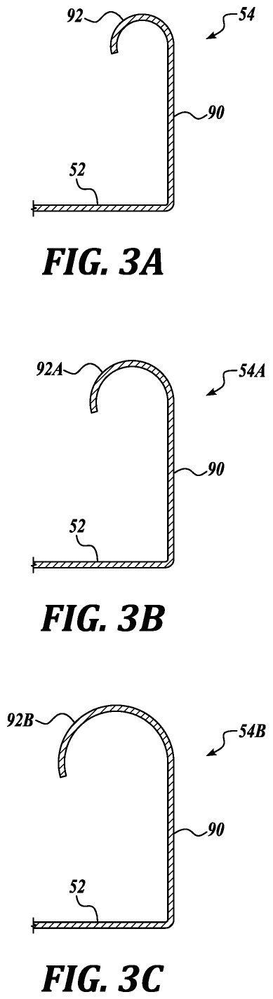

Referring to FIGS. 1, 3A, 3B, and 3C, a flange connector 54 is illustrated as formed at each end of the duct 52. The flange connector 54 includes a mating flange portion or face 90 extending laterally or transversely to the length of duct 52. The distance that the mating flange portion 90 extends transversely to the duct 52 is variable, depending on factors such as the overall size of the duct 52, the thickness or material gauge of the duct 52, and the type of material from which the duct 52 is formed. For example, for a duct 52 having a major axis of 30 inches and a minor axis of 15 inches, the mating flange portion may extend radially from the duct 52 for from ¾ inch to at least 2 inches.

A reinforcing seat 92 is formed along the outer perimeter of the mating flange 90 to add stiffness and structural integrity to the mating flange. As shown in the drawings, the reinforcing seat 92 is in the form of a reverse curl, meaning that the reinforcing seat extends away from the mating surface 90, then downwardly toward the exterior of the duct 52. The reinforcing seat 92 is shown in FIGS. 3A, 3B, and 3C as increasing in size. This increase in size results in a corresponding increase in the stiffness of the mating flange portion 90 without increasing the thickness of the material or gauge from which the duct system 50 is constructed.

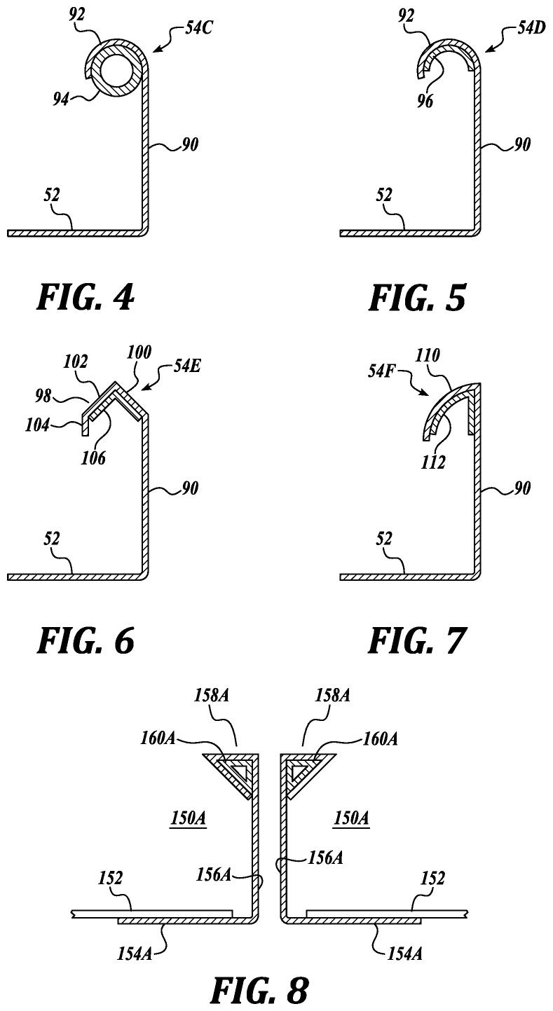

Another method for increasing the stiffness of the connection flange 54C is to wrap the seat portion of the reinforcing seat 92 about a reinforcing member, such as member 94 shown in FIG. 4. The reinforcing member is shown in the form of a hollow tube 94. It can be appreciated that the reinforcing member may be in the form of a solid circular rod as opposed to a hollow tube.

FIG. 5 shows a further embodiment of the present disclosure wherein the connector 54D employs a generally semi-circular shaped reinforcing member 96 that is securely captured within the interior of the correspondingly-shaped reinforcing seat 92. The reinforcing member 96 cam be used where it is desired to employ a lighter weight reinforcing member, or where the level of reinforcement needed for the connector 54D is not as high as for the connector 54C.

The reinforcing seat employed in conjunction with connectors 54 may be of other shapes, for example, in FIG. 6, the reinforcement seat 98 of connector 54E is in an angular form having a first leg 100 extending diagonally radially outwardly and away from the mating surface of flange portion 90 to intersect with a second leg 102 that extends radially inwardly and rearwardly from the flange portion 90, and then a short vertical leg 104 extending downwardly from the second leg 102. It may be that the reinforcing seat 98 can be constructed without the third leg portion 104. An angularly-shaped reinforcement member 106 is captured within the reinforcing seat 98 to add structural integrity to not only the reinforcing seat, but also the connector 54E in general.

Another form of a reinforced connector 54F is shown in FIG. 7 wherein reinforcing seat 110 is arcuate in shape, generally in the form of a quarter circle. A comparably-shaped reinforcing member 112 is securely captured by the reinforcing seat 110. As show in FIG. 7, the reinforcing member 112 includes an arcuate section that underlies the reinforcing seat 110 as well as a vertical section that is in face-to-face relationship with the adjacent surface of the mating flange portion 90. As apparent, the reinforcing member 112 adds significant structural integrity to not only the reinforcing seat 110, but the entire mating flange portion 90.

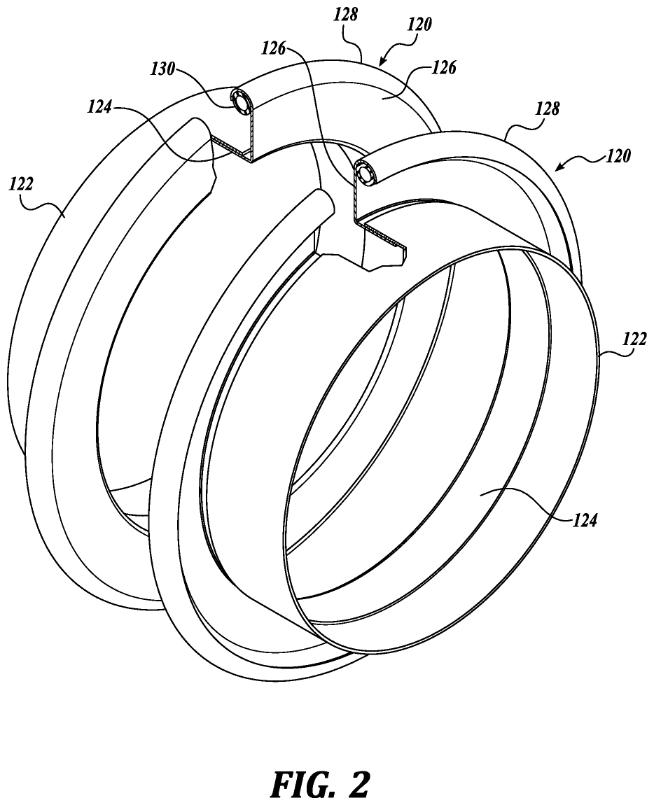

Although several variations of reinforcing seats have been illustrated and described, it can be appreciated that reinforcing seats of other configurations may be employed. As shown in FIGS. 1 and 3-7, the reinforcing seats extend in the direction away from the mating flange portion 90. As a consequence, the radial dimension of the mating flange portion 90 can be minimized. This is important when the mating flange portions are employed with elliptically-shaped ducting, especially when such ducting is utilized due to a height restriction for the ducting. However, it can be appreciated that various configurations of the reinforcing seat 92, though in a “reverse” position with respect to the mating flange portion 90, can also be utilized in conjunction with ducting that is of other cross-sectional shapes, including circular ducting as shown in FIG. 2.

Referring to FIG. 2, flange connectors 120 are constructed as ring structures that are separate from the circular HVAC ducting 122, and are attached to the ends of the ducting to couple two ducting sections 122 together in end-to-end relationship. In profile, the flange ring connectors 120 are similar to the flange ring connector 54c shown in FIG. 4, except that the connectors 120 are used to interconnect circular ducting 122 as opposed to elliptical ducting, such as duct 52 shown in FIG. 1.

The connector 120 includes an insertion flange portion 124 to engage closely within the interior of the duct 122, as well as a mating flange portion 126 extending laterally or transversely to the insertion flange portion 124. As in the flange connector 54C, the connectors 120 include a reinforcing seat 128 extending around the outer perimeter of the mating flange portion 126. The reinforcing seat is in the shape of a reverse curl, as also employed with the connectors 54C and 54D described above. Further, as in the flange connector 54C the flange ring connectors 120 utilize a reinforcing rod 130, which is closely held by the reinforcing seat 128 so as to increase the structural integrity and stiffness of the mating flange portion 126 as well as for the flange ring connector 120 in general.

The flange ring connectors 120 may be attached to the corresponding ends of duct 122 in a standard manner, for example, by hardware members extending through the insertion flange portion 124 of the flange ring connector 120 and through a corresponding location of the ducting 122.

Although the flange ring connector 120 shown in FIG. 2 corresponds to the connector 54 shown in FIG. 4, which is “built into” the ends of duct 52, it will be appreciated that flange ring connectors corresponding to connectors 120 can be of other configurations, such as shown in FIGS. 5, 6, and 7, described above. Moreover, such flange ring connectors can be employed to interconnect ducting of different cross-sectional shapes, including circular ducting, flat oval ducting, as well as elliptical ducting.

The flange connectors, as well as the flange ring connectors discussed above and as discussed below, can be manufactured by different techniques, including those techniques described more fully herein. In this regard, the connectors and flange ring connectors may be manufactured solely by spin-forming, solely by roll-forming, solely by stamping, or by a combination thereof. Also, with respect to the flange ring connectors, the starting work material may be composed of strip stock that is first formed into a circular ring and then the profile of the flange ring connector formed therein. Thereafter, the formed flange ring connector can be formed into an elliptical shape using, for example, the techniques described above with respect to FIGS. 23A and 23B.

Alternatively, the profile of the flange ring connector may be first formed into the strip stock and then the strip stock formed into a circular, elliptical, or flat oval configuration to match the cross-sectional shape of the HVAC ducting being interconnected. Further, the beginning workpiece may be angular in shape, whether a circular annulus, an elliptical annulus, etc. The profile of the flange ring connector can be stamped into the beginning workpiece.

As a further alternative, the workpiece may be square, rectangular, or circular in shape, wherein the stamping process is utilized whereby several flange ring connectors are stamped out of the workpiece at the same time of various sizes so that flange ring connectors are nested one within the other. The following description provides some examples of forming the flange ring connector in accordance with the present disclosure.

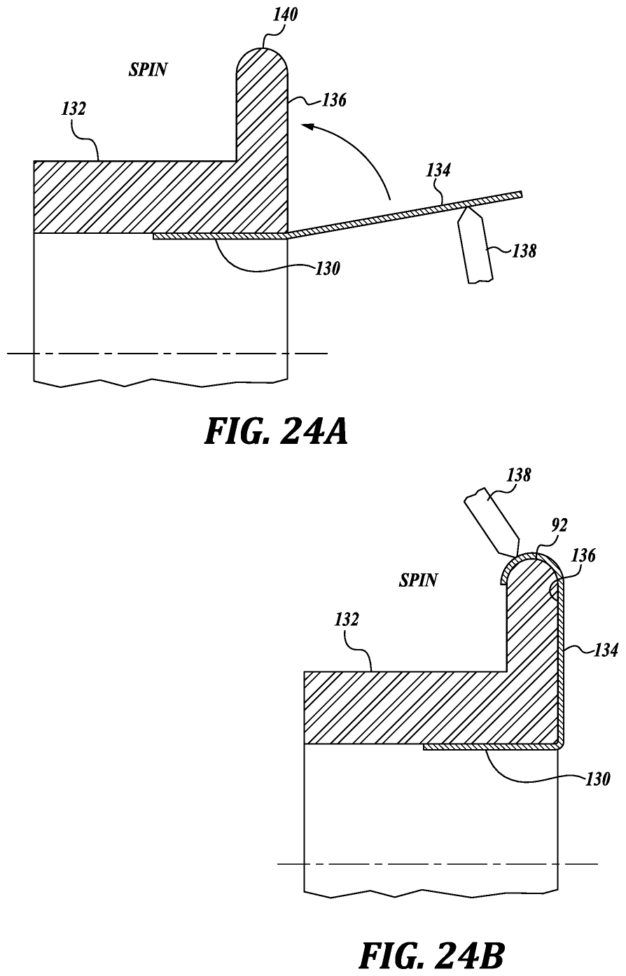

FIGS. 24A and 24B illustrate one manner of forming the flange ring connector of FIGS. 4 and 5. In FIG. 24A, a round collar-shaped workpiece 130 is held within a spin die 132, so that a portion 134 of the workpiece 130 extends beyond the forward face 136 of the spin die. Such projecting portion 134 is bent or turned upwardly against the forward face 136 by a tool 138 while the workpiece is spinning within the spin die 132. Thereafter, the same tool 138, or a different tool, is used to form the workpiece against the rounded outer perimeter portion 140 of the die 132 to form the reverse curl portion corresponding to reinforcing seat 92. If the connector is to be employed to interconnect elliptically-shaped ducting, then the flange connector as shown in FIG. 24B may be transformed from a round cross section to an oval cross section using the procedure described above with respect to FIGS. 23A and 23B. A reinforcing member, such as member 94, can be placed in the reinforcing seat 92 before the connector is transformed into an oval shape.

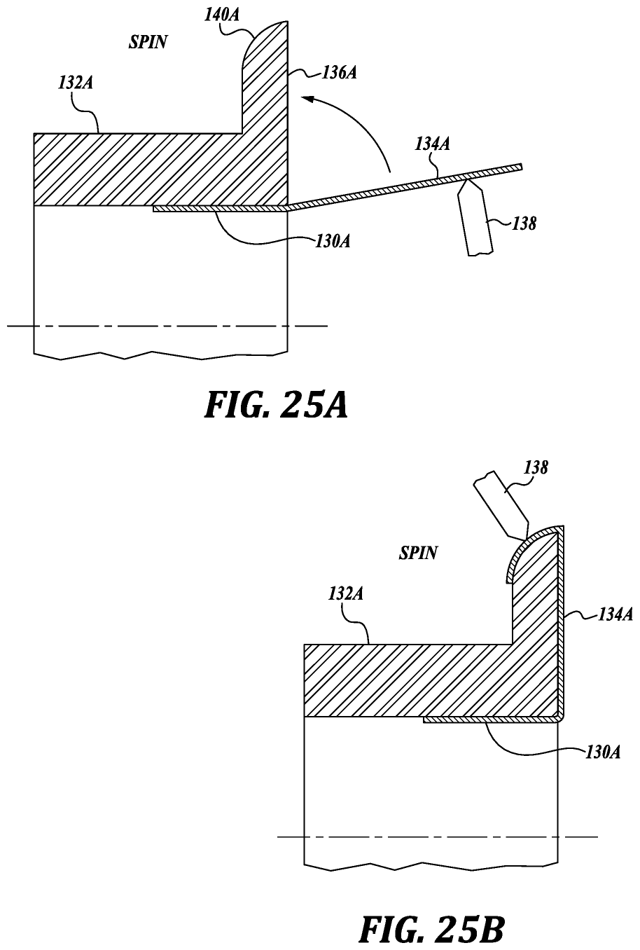

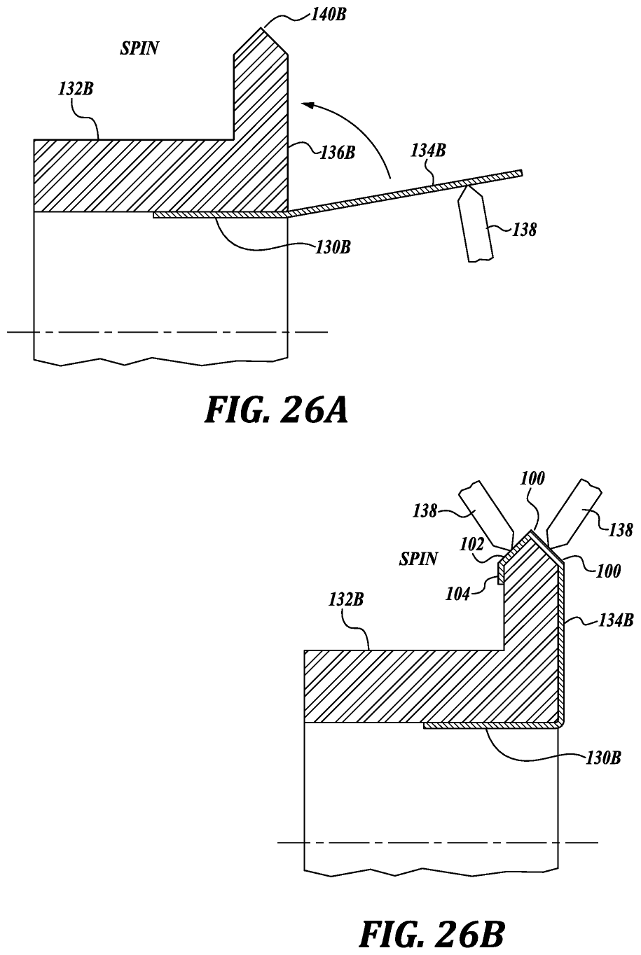

FIGS. 25A and 25B illustrate how a flange ring connector having the profile of FIG. 7 may be made, whereas FIGS. 26A and 26B illustrate how the flange ring connector having the profile of FIG. 6 may be made. The steps of such methods correspond to those described above with respect to FIGS. 24A and 24B, and thus will not be repeated here.

The above described techniques for manufacturing flange ring connectors can also be used to form the various connectors described above directly onto the ends of ducting whether of elliptical, round, oval, or other cross-sectional shapes.

FIGS. 8-14 pertain to various embodiments of flange ring connectors 150 for connecting the adjacent ends of HVAC ducting 152, whether elliptical, circular, or other cross-sectional shapes. The flange ring connectors 150 are similar in that they include an insertion flange portion 154 to engage within the interior of the duct 152, and is of a shape corresponding to the cross-sectional shape of the duct 152. The flange ring connector 150 also includes a mating flange portion 156 extending laterally or transversely to the insertion flange portion 154. A “reverse location” reinforcing seat 158 is formed along the outer perimeter of the mating flange portion 156. The reinforcing seat 158 can be of various configurations, as shown in FIGS. 8-14.

In FIG. 8, the reinforcing seat 158A is triangular in form having an upper leg extending transversely away from the mating flange portion 156, parallel to the length of the ducting 152, and then a diagonal leg portion extends downwardly and towards the mating flange portion 156 to complete the triangular shape. The correspondingly-shaped reinforcing member 160A is disclosed within the interior of the reinforcing seat 158A. A common characteristic of the reinforcing seat 158 of the embodiments of the present disclosure shown in FIGS. 8-14 is that the reinforcing seat is shaped to form a closed seat, which enhances the structural integrity of the connector; however, the reinforcing seat can be formed so as to not completely close.

Also, in each of the exemplary flange ring connectors show in FIGS. 8-14, the reinforcing seat extends away from the mating flange portion 156. In addition, the mating flange portion 156 extends substantially to the maximum radial distance away from the insertion flange portion 152 before the formation of the seat 158 is initiated. As such, the area of the mating flange portion which is available for face-to-face abutment with the corresponding flange ring connector is maximized. This is especially true in the situations in which the reinforcing seat 158 forms a sharp corner with the mating flange portion at the outer perimeter of the mating flange portion, for example, in FIGS. 8, 9, and 11-14. This is advantageous in that the radial distance that the mating flange projects from the insertion flange may be minimized, thereby minimizing the overall height of the HVAC ducting structure when limited height for the HVAC ducting structure is available, and thus an elliptically-shaped or flat oval-shaped duct is utilized.

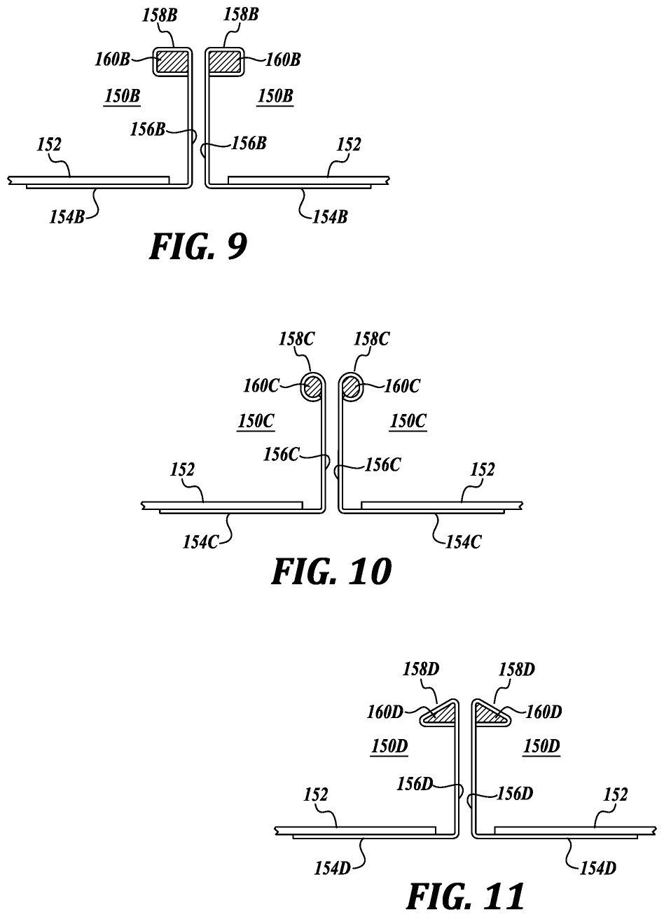

The flange ring connector 150B shown in FIG. 9 includes a generally rectangularly-shaped reinforcing seat 158B of a “closed in” configuration. The reinforcing member 160B corresponds to the shape of the seat 158B.

The flange ring connector 150C shown in FIG. 10 is constructed with a seat 158C that is generally circular in shape so as to capture a correspondingly-shaped reinforcing member 160C therein.

The flange ring connector 150D shown in FIG. 11 is constructed with a reinforcing seat 158D that is similar in shape to the reinforcing seat 158A shown in FIG. 8, but with the “horizontal” section of the triangularly-shaped seat being at the “bottom” of the seat as opposed to the very outer perimeter of the mating flange portion 156A shown in FIG. 8. Further, the reinforcing member 160D is captured within the interior of the reinforcing seat 158D.

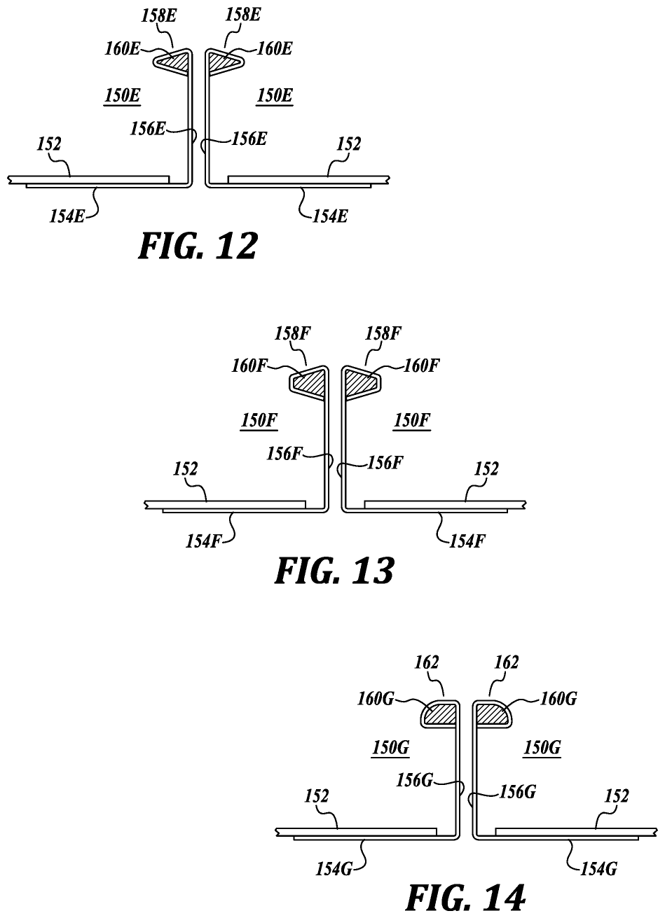

The reinforcing seat 158E of the flange ring connector 150E shown in FIG. 12 is also generally triangular in shape, however with both the upper and lower legs of the triangle being correspondingly diagonally positioned with respect to the mating flange portion 156E. Again, the reinforcing member 160E is securely captured within the interior of the reinforcing seat 158E.

In the flange ring connector 150F shown in FIG. 13, the reinforcing seat 158F is similar to that shown in FIG. 12, except the tip portion of the triangularly-shaped reinforcing seat 15Ff is truncated. The shape of the reinforcing member 160F is similarly in the form of a truncated triangle.

The reinforcing seat 158G shown in FIG. 14 is generally triangular in shape similar to the reinforcing seat 158b shown in FIG. 9, but with the exception that the outer corner 162 located furthest from the insertion flange portion 154 is rounded rather than square. As such, the reinforcing member 160G likewise is shaped with a correspondingly rounded corner so as to be closely encircled by the reinforcing seat 158G.

Although various configurations of reinforcing seats 158 are shown in FIGS. 8-14, it is to be understood that the reinforcing seat can be of numerous other configurations.

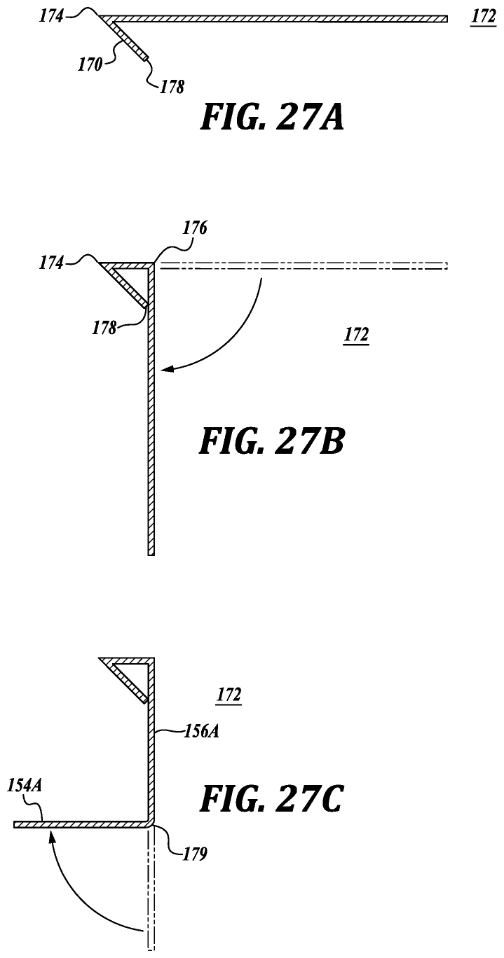

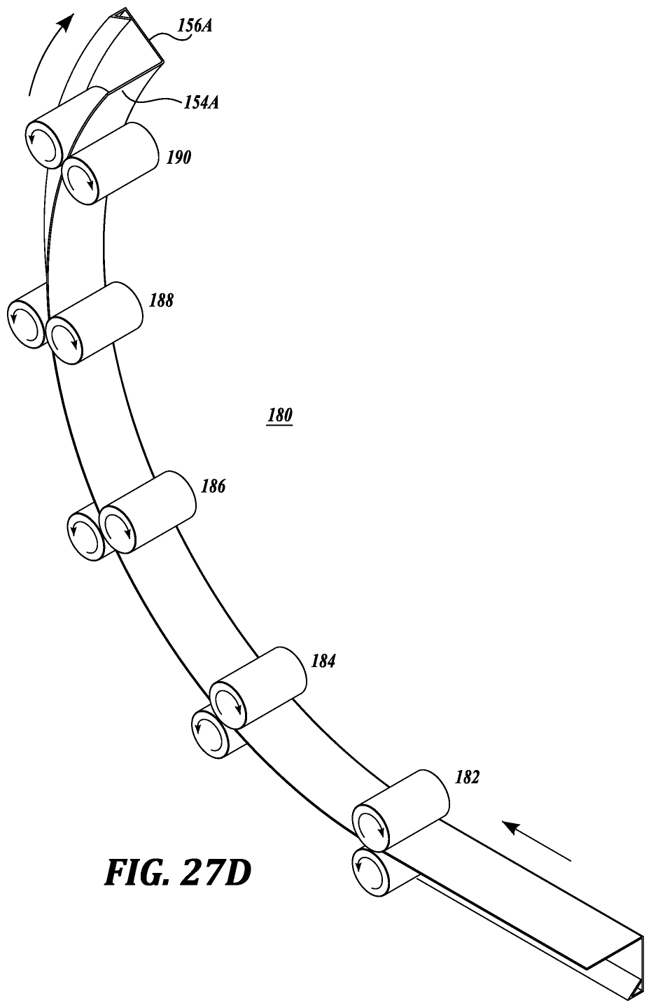

As with the flange connectors and flange ring connectors shown in FIGS. 1-7, the flange ring connector shown in FIGS. 8-14 can also be constructed by various techniques. For example, the flange ring connector of FIG. 8 can be constructed as illustrated in FIGS. 27A-27D. In this regard, one edge portion 170 of a workpiece 172 in the form of an elongated strip can be bent over to form a sharp corner 174. Thereafter, the workpiece 172 can again be bent to form a right-angle corner 176 with the free end or tip 178 of the initially bent portion 170 contacting against the workpiece strip, which is primarily in a vertical orientation, as shown in FIG. 27B, to form the mating flange portion of the flange connector. Next, the vertical section of the workpiece shown in FIG. 27B is bent into a right angle at corner 179, as shown in FIG. 27C, to form the insertion flange portion 154A.

The workpiece as shown in FIG. 27C is in the form of a straight, elongated member. A roller set 180 is used to form the workpiece into a circular or elliptical shape. The roller set 180 is composed of pairs of rollers 182, 184, 186, 188, 190 that progressively increase the curvature of the workpiece so as to form the strip stock workpiece into a substantially round shape. Thereafter, an elliptical shape can be achieved by using the methodology discussed above with respect to FIGS. 23A and 23B.

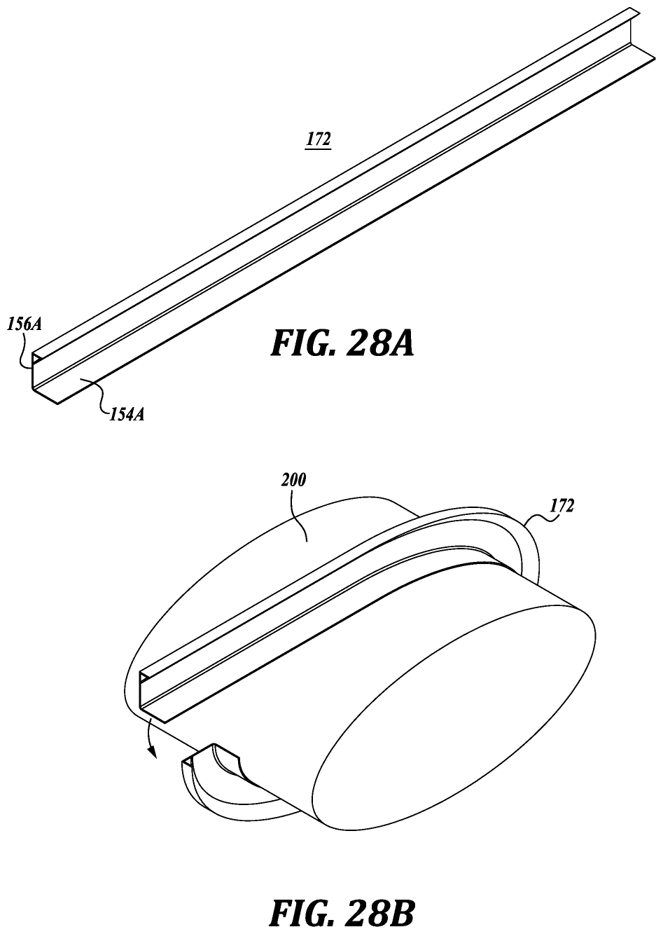

An alternative method of forming the straight workpiece of FIG. 27C into an elliptical shape is shown in FIGS. 28A and 28B. In FIG. 28A, the workpiece is in an elongated form, but with the profile shown in FIG. 27C. An elliptical shape can be achieved by grasping the ends of the workpiece shown in FIG. 28A and wrapping the workpiece around an oval die 200 shown in FIG. 28B. As the workpiece is wrapped around the oval die, it is also stretched a very small amount, but sufficiently so that the workpiece retains the elliptical shape of the die 200. The ends of the now elliptically-shaped connector can be attached together in a standard manner, for instance by welding.

As an alternative, the cross-sectional profile shown in FIG. 27C can produced by extruding the profile using an extrusion die. In this regard, the material used can be typical HVAC ducting material, or could be a softer material, such as aluminum. Once extruded into desired lengths, the lengths can be formed in an elliptical shape using the techniques noted above, such as roll forming or wrapping around an oval die, or by other techniques. It can be appreciated that by use of an extrusion, the cross-sectional profile produced can be of various shapes, including, but not limited to the shapes disclosed herein, including shapes having integral reinforcing members, for example, such as show in FIGS. 8-14 herein.

Although the flanged ring connectors above, including connectors 54A-54F, 120, and 150A-150G have been described as constructed from metallic material, including typical material used for HVAC ducting and fittings, it is to be understood that these connectors can be constructed from other types of materials, for example, fiberglass, thermoplastics, and fiber reinforced thermoplastics. Constructing the connectors from these additional materials expands the options for manufacturing the connectors. These additional materials enable the connectors to be manufactured, for example, by injection molding. Injection molding can be used to produce the entire connector as a single unit. In order to achieve the undercuts, the mold may need to be composed of movable sections, which is commonly used when manufacturing products of such shape.

As an alternative, the non-metallic connectors can be extruded using the die that corresponds to the cross-sectional shape of the connector. Lengths of such extrusions can be formed around or formed within a die that defines the desired elliptical, circular, or other overall shape of the connector so as to match the cross-sectional shape of the ducting being interconnected.

The flanged ring connectors formed from these additional materials can be used to successfully interconnect HVAC ducting or other ducting or piping constructed from both metallic materials as well as from fiberglass, thermoplastic, and fiber reinforced thermoplastics materials. Further, it will be appreciated that the above-described techniques for reinforcing the flanged connectors can also be used in conjunction with flanged ring connectors composed of these additional materials.

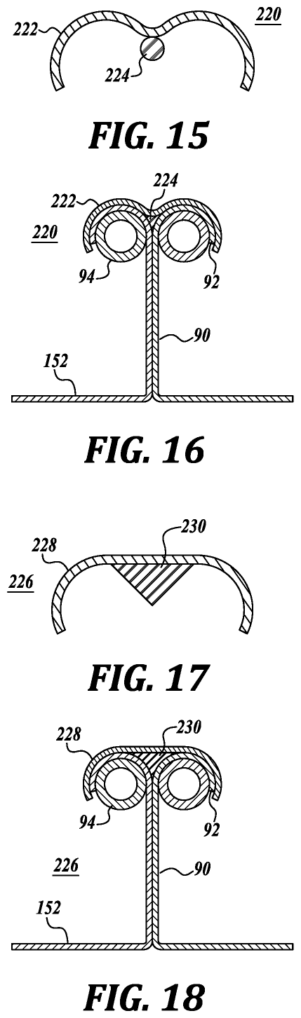

Next, referring to FIG. 15, a closure band assembly 220 is illustrated for securing flange ring connectors together, such as the connectors shown in FIGS. 2, 3A-3C, 4, and 5. The assembly 220 includes a band portion 222, which in cross section, as show in FIG. 15, is composed of two arcuate sections that are concave in cross section, joined by a center convex section. The concave sections encircle the reinforcing seat portions 92 of the mating flange portions 90, thereby to securely capture the reinforcing seats causing the mating flange portions to be pressed together in face-to-face relationship, as shown in FIG. 16. A seal 224, shown as circular in cross section, is affixed to the convex portion of the band 222 so that when the band assembly is secured in place, the seal occupies the gap between the adjacent reinforcing seats 92, thereby to form an airtight seal therebetween.

It can be appreciated that the closure band assembly 220 can be pre-formed, by roll forming or other standard techniques, into the overall shape of the connector, for example whether the elliptically-shaped connector 54 shown in FIG. 1, the circularly-shaped flange ring connectors 120 shown in FIG. 2, or otherwise. Also, it can be appreciated that once installed in place, the ends of the closure band assembly 220 can be simply fastened together, for example, by use of hardware members.

FIGS. 17 and 18 illustrate closure band assembly 226 of another embodiment to the present disclosure. In closure band 226, the band member 228 includes rounded end sections connected by a straight intermediate section. As shown in FIG. 18, the rounded end sections encircle and capture reinforcing seats 92 therebetween. A triangularly-shaped seal 230 is attached to the inside surface of the band 228 to occupy the gap between adjacent reinforcing seats 92, thereby to form an airtight seal therebetween. As in closure band assembly 220, the band assembly 226 can also be pre-formed to match the shape of the connectors being fastened together. Also, once in place the ends of the band 228 can be secured as discussed above with respect to band 222.

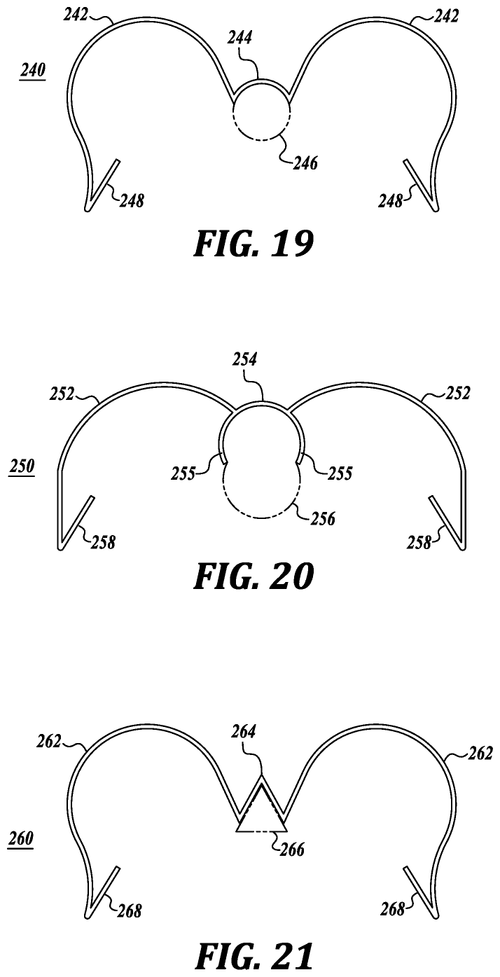

FIGS. 19, 20, and 21 illustrate other configurations of closure bands 240, 250, and 260, in accordance with the present disclosure. The closure band 240 illustrated in FIG. 19 is in the form of two arcuate sections 242 interconnected by a central arcuate section 244 that functions as a seat for a compressible seal 246 in the manner of seal 224 described above. The closure band 240 also includes lower, distal hook sections 248 which can be used to attach to the free end portions of a reinforcing seat, for example, reinforcing seat 92 shown in FIG. 5 or reinforcing seat 110 shown in FIG. 7. Thus, hook sections 248 assist in retaining the closure band 240 engaged with flange connectors.

The closure band 250 shown in FIG. 20 is constructed similarly to the closure band 240, with the exception being that the central connecting section 254 includes tangs 255 to capture in place an elastomeric seal 256. This construction avoids needing to separately affix the elastomeric seal 256 in place, for example, by use of an adhesive.

The closure band 260 is also constructed similarly to the closure bands 240 and 250, with the exception that the central connector or bridging section 264 is in the form of a concave triangle for receiving therein a triangularly-shaped elastomeric seal member 256 to seal the gap between adjacent reinforcing seats, such as reinforcing seats 92. Other than with this exception, the closure band 260 shown in FIG. 21 is of similar construction to the closure bands 240 and 250 described above.

It will be understood that closure bands can be configured to correspond to the shapes of the reinforcing seats being utilized. The closure bands described above are designed to be used with reinforcing seats in the shape of a reverse curl, as shown in FIGS. 1-5. Nonetheless, the closure bands can be configured to be used with reinforcing seats of other shapes, for example, as shown in FIGS. 4-14. Such closure bands may or may not employ a seal such as seals 224, 230, 246, 256, or 266, as described above. Also, if a seal is employed, the seal may be positioned in other locations relative to the closure band, for instance, along the underside of the closure band, i.e., the surface of the closure band facing the reinforcing seat.

As will be appreciated, the closure bands shown in FIGS. 15-21, can be manufactured by of variety of different techniques. For example, the profile of the closure bands can be formed by stamping, and then the overall shape of the closure band, whether circular, elliptical or otherwise, can be performed by roll forming, shown in FIG. 27D, and optionally by expanding, as shown in FIGS. 23A and 23B. Alternatively, the closure bands may be produced by solely roll forming.

The foregoing closure bands can be made from materials other than typical HVAC ducting materials, which is typically formed from the type of steel. Instead, the closure band could be made from fiberglass, a thermoplastic or a thermoplastic reinforced with fiberglass, or carbon fibers. In this regard, the closure band could be initially mounted on one flanged connector, and then during installation of the ducting the closure band can be slipped over the flanged connector of the adjacent ducting. The closure band can be constructed with sufficient flexibility and expandability to capture the flanged connector of the adjacent duct section.

As an alternative the closure band can be constructed in the form of an elastic band of sufficient width to extend over to adjacent flanged connectors. Such elastic bands can be constructed to be of sufficient strength to securely and tightly interconnect the flanged connectors in face-to-face relationship to each other, as shown in FIGS. 16 and 18. Such elastic bands can be constructed with slightly expendable cables integrated along the longitudinal edge portions of the elastic band so as to provide reinforcing for the band portion of the connector.

It is to be appreciated that rather than using an elastic band, other types of band or strap material may be utilized to function as a closure band for interconnecting flanged connectors of the present disclosure.

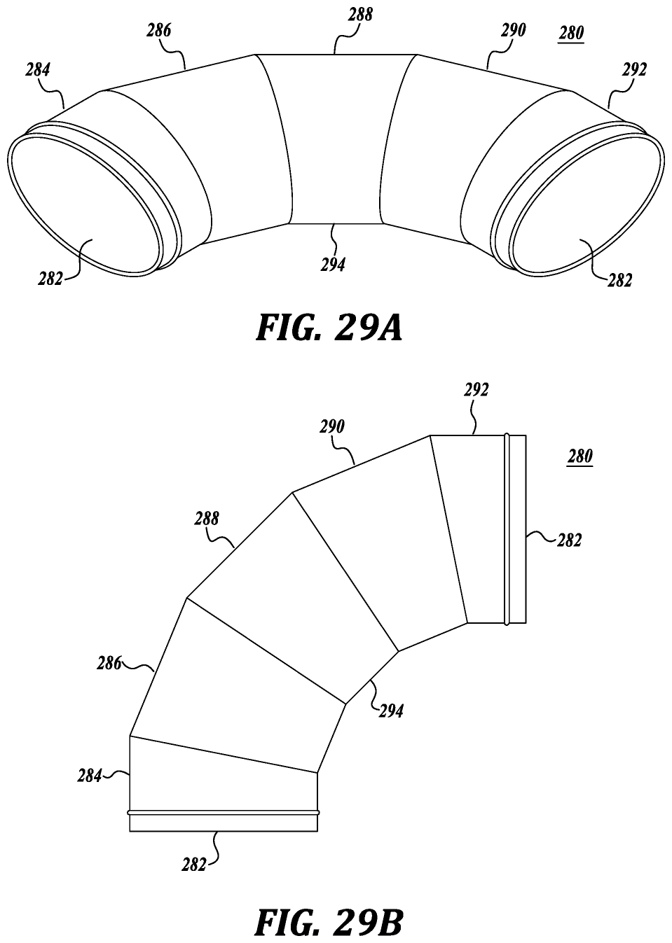

FIGS. 29A-37B illustrate various types of fittings in accordance with the present disclosure. Such fittings are arcuate in cross-sectional shape, so as to be compatible with the ducting system 50 shown in FIG. 1. In this regard, FIGS. 29A and 29B illustrate a five-segment 90-degree elbow 280. The elbow 280 has arcuate end openings 282 and five individual segments 284, 286, 288, 290, and 292. Each segment is defined by an overall flat two-dimensional pattern that when cut from a flat sheet and then when formed and assembled together results in the elbow 280 shown in FIGS. 28A and 28B. This flat pattern can be cut so that it is formed to create a seam 294 along the inside curvature and/or outside curvature of the elbow that can be welded or otherwise fastened together. In this regard, the location of the seam can alternate between the inside and the outside of the elbow curvature in adjacent sections of the elbow. Further, the seam can be located anywhere around the circumference of the elbow.

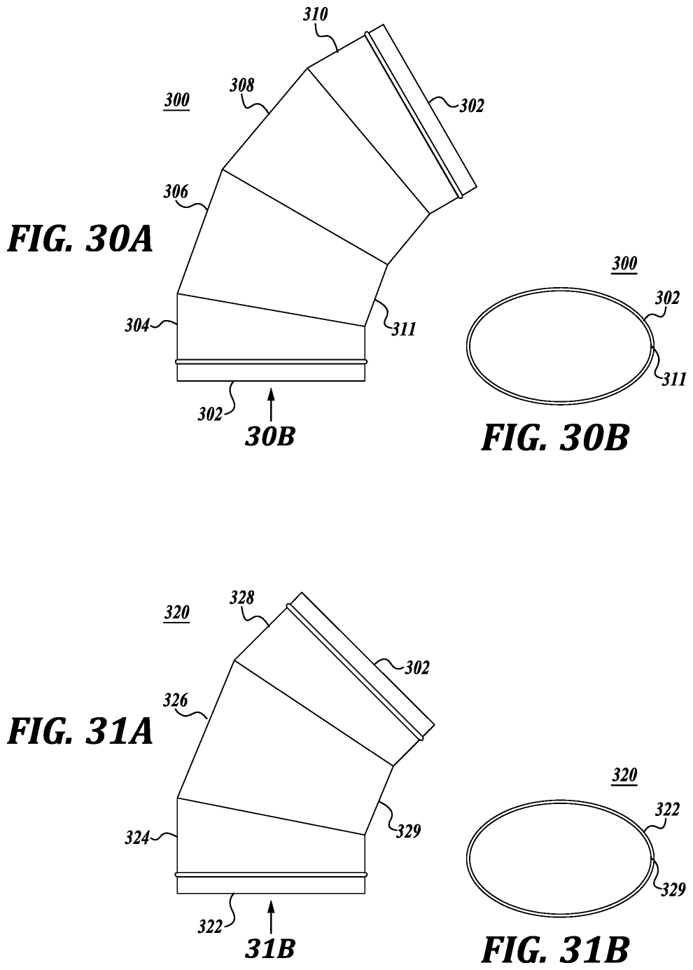

FIGS. 30A and 30B illustrate a 60-degree elbow composed of four segments, with the elbow being elliptical in cross-section as shown by the ends 302 thereof. The elbow 300 consists of four segments 304, 306, 308, and 310. As in elbow 280, elbow 300 is defined by a flat pattern that can be cut from flat stock, then formed and assembled together to produce the shape of the elbow shown in FIGS. 30A and 30B. This flat pattern can be cut so that it is formed to create a seam 311 along the inside and/or outside curvature of the elbow that can be welded or otherwise fastened together. As noted above, the location of the seam can alternate between the inside and the outside of the elbow curvature in adjacent sections of the elbow.

FIGS. 31A and 31B illustrate a 45-degree elbow 320 of elliptical cross section with regard to the ends 322 of the elbow are shown in the form of an ellipse. The elbow 320 is constructed from three segments 324, 326, and 328, as shown in FIG. 31A. As in the elbows 280 and 300, the elbow segments 324, 326, and 328 also can be defined by a flat two-dimensional pattern. This pattern can be cut from flat stock and then the patterned sections formed into an ellipse and assembled together to result in the configuration shown in FIGS. 31A and 31B. This flat pattern can be cut so that it is formed to create a seam 329 along the inside or outside curvature of the elbow circumference or anywhere along the elliptical of the elbow that can be welded or otherwise fastened together. The locating of the seam at any location along the elliptical circumference of the fitting applies to all of the fitting disclosed herein.

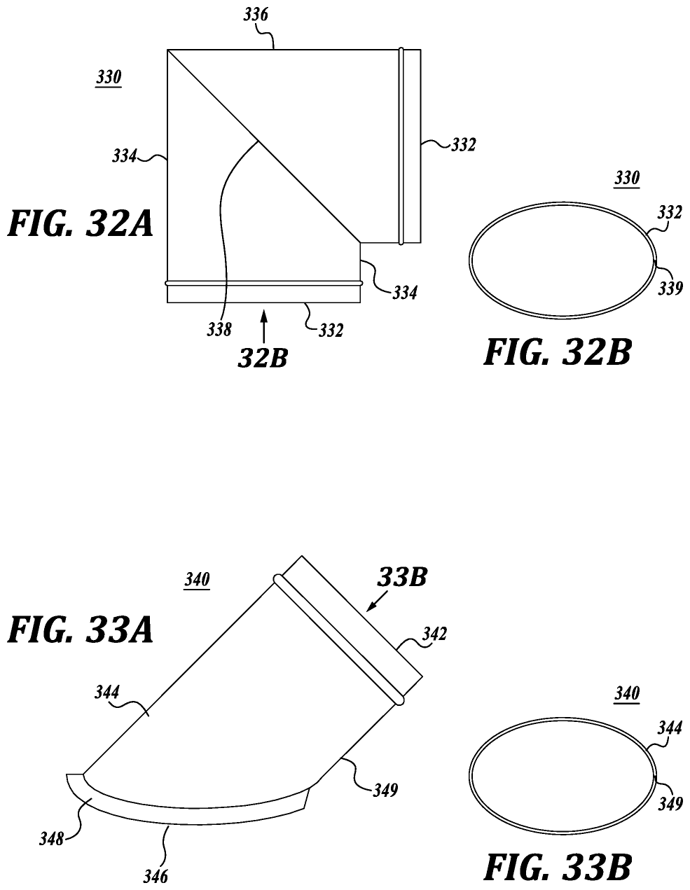

FIGS. 32A and 32B illustrate a 90-degree elbow 330 of mitered construction, but with an oval cross-section, as shown by the ends 332 of the elbow. The elbow is constructed from two segments 334 and 336. The elbow 330 can be defined by a flat two-dimensional pattern, which may be cut from flat stock and then formed into an oval shape, and then the seams closed to form the elbow shown in FIGS. 32A and 32B. This flat pattern can be cut so that it is formed to create a first diagonal seam 338 and then a second inside seam 339 along the inside curvature of the elbow that can be welded or otherwise fastened together. Of course, the second seam could be along the outside curvature of the elbow. Further, the seams can be at other locations about the elbow.

FIGS. 33A and 33B illustrate a lateral or angle tap 340 of elliptical cross section as shown by the end 342 thereof. The angle tap 340 includes a longitudinal section 344 having a “squared” elliptical end 342 and an angled opposite end 346 around which a flange portion 348 extends around. The end 346 of the angled tap is shown at a 45-degree angle, but can be of different angles, such as, for example, 30 degrees or 60 degrees. This flat pattern can be cut so that it is formed to create a seam 349 along the side of the tap or anywhere around the elliptical circumference of the tap, that then can be welded or otherwise fastened together.

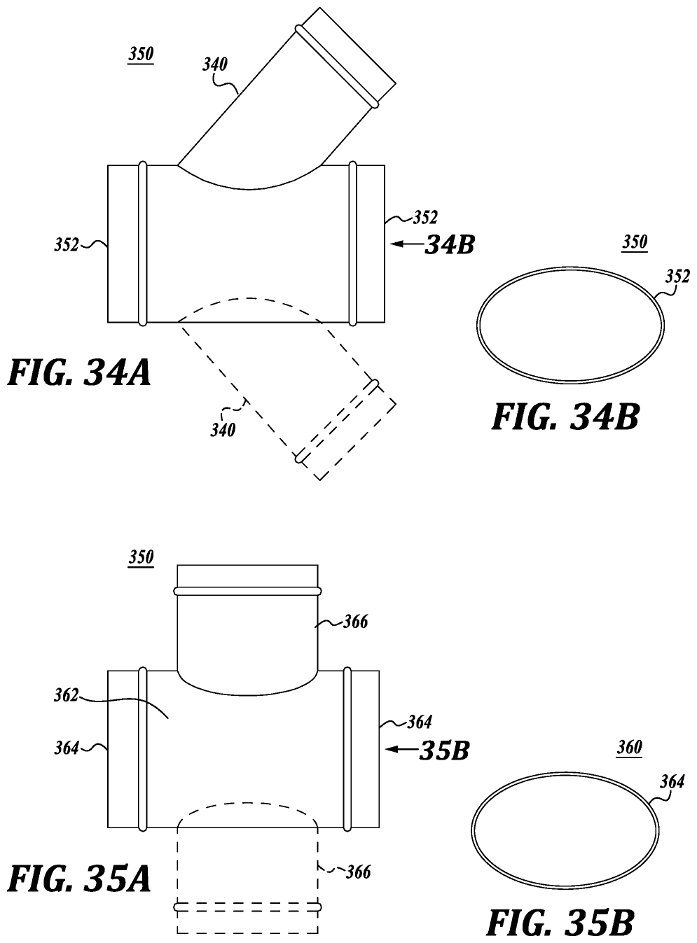

The angle tap 340 can be utilized in conjunction with various types of connectors, such as lateral 350 shown in FIGS. 34A and 34B. The lateral 350 is of elliptical cross section as shown by the ends 352 of the lateral. As shown in FIG. 34A, the lateral 350 can be of a single lateral construction having a single angle tap 340 or may be of a double lateral construction having two angled taps 340, or even with triple or quadruple angle taps. Moreover, the taps can be various angles relative to the lateral, and the angles of the taps do not all have to be the same, but can vary.

FIGS. 35A and 35B illustrate a T-fitting 360 having major section 362 of oval cross section as shown by the ends 364 thereof. The lateral section (S) 366 is also oval cross section, as shown in FIG. 35A; a second lateral 366, as shown in broken line, can also be employed, wherein the fitting 360 is a double T.

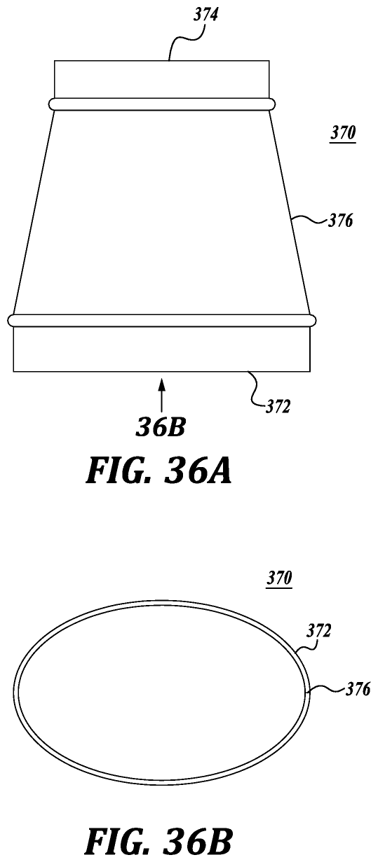

FIGS. 36A and 36B illustrate a reducer 370 having elliptical ends 372 and 374, but of different sizes. As in the other fittings discussed above, the reducer 370 can be defined by a flat pattern which can be cut from flat stock and then formed into the shape shown in FIGS. 36A and 36B. This flat pattern can be cut so that it is formed to create a seam 376 along one side of the reducer that can be welded or otherwise fastened together.

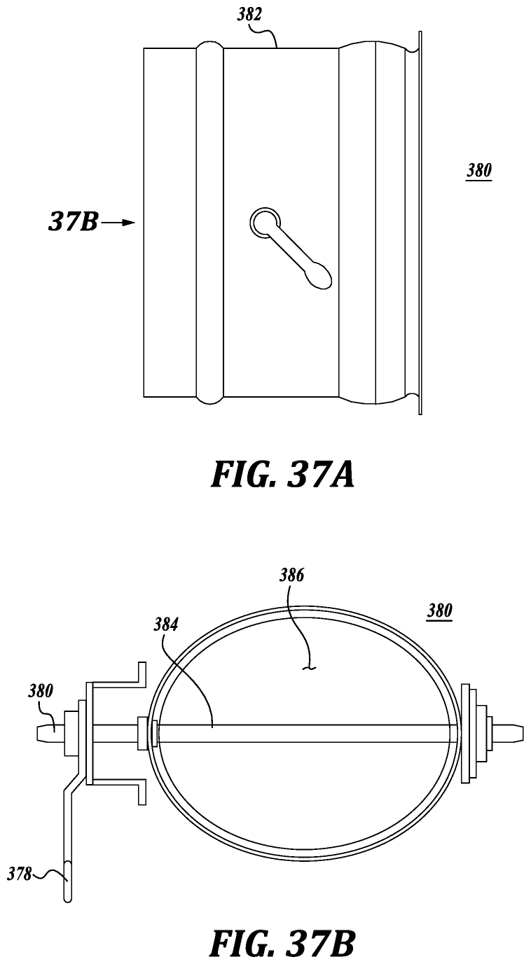

FIGS. 37A and 37B illustrate a damper 380 of oval cross section, as shown by FIG. 37B. The damper includes an outer housing or shell 382 with an axle 384 extending along the major axis of the elliptical cross section. A damper plate 386 is mounted to the axle 384. A handle 388 extends transversely from the end 390 of the axle 384 positioned outwardly from the housing 382 to thereby control the position of the damper plate 386 within the housing 382 in a standard manner. As discussed above, with respect to other components of the present disclosure, the damper housing 382 can be constructed by roll-forming, spin-forming, stamping, or a combination thereof.

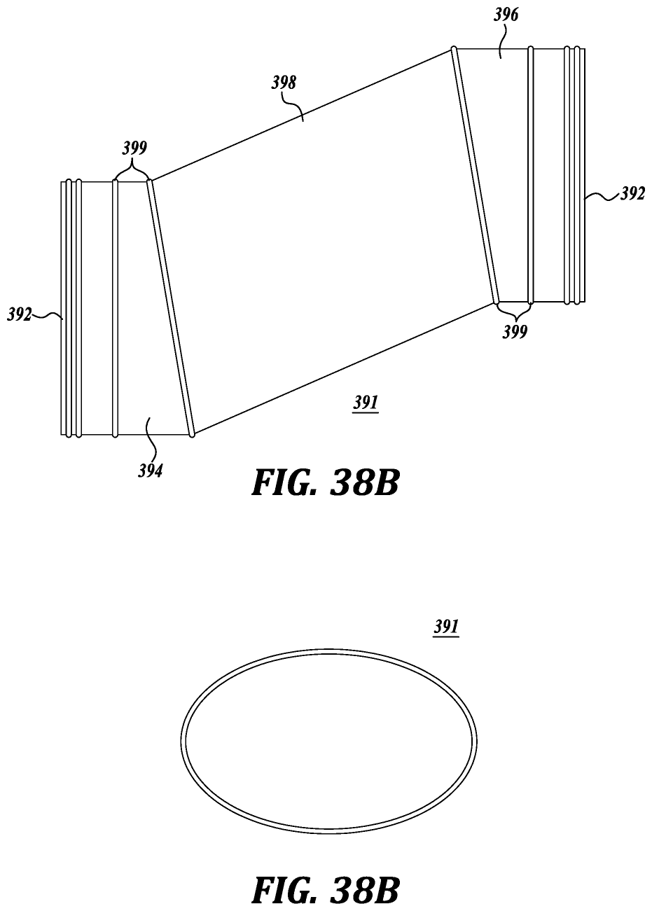

FIGS. 38A and 38B illustrate an offset connector 391 formed in an oval cross-section as shown in FIG. 38B. The connector 391 includes parallel ends 392 connected to parallel end sections 394 and 396, which are in turn interconnected by a diagonal section 398. The offset connector 391 can be define by a flat pattern that can be cut from flat stock, then formed and assembled together to produce the shape of the connector shown in FIGS. 38A and 38B. This flat pattern can be cut so that it is formed to create a seam along a desired location about the elliptical circumference of the connector that can be welded or otherwise fastened together. Also, as typical, circumferential reinforcing ridges 399 can be formed in the connector to provide increased structural integrity. It will be appreciated that by the above construction, the cross-sectional area, and shape, of the connector is maintained along the length of the connector.

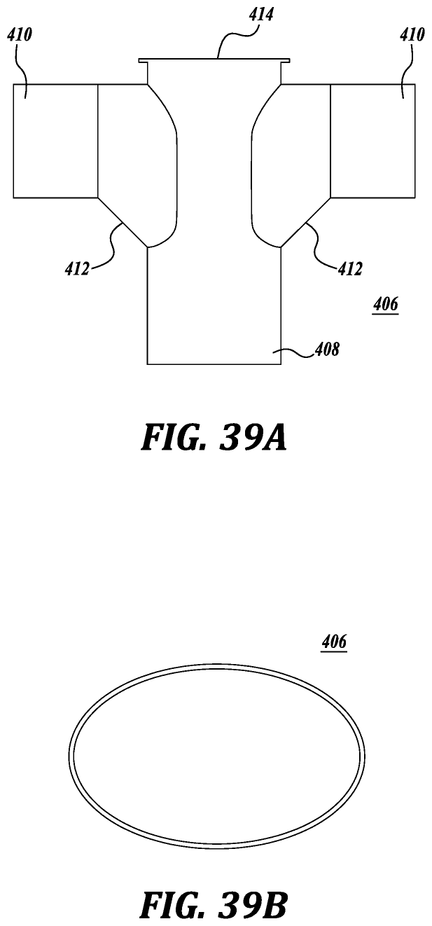

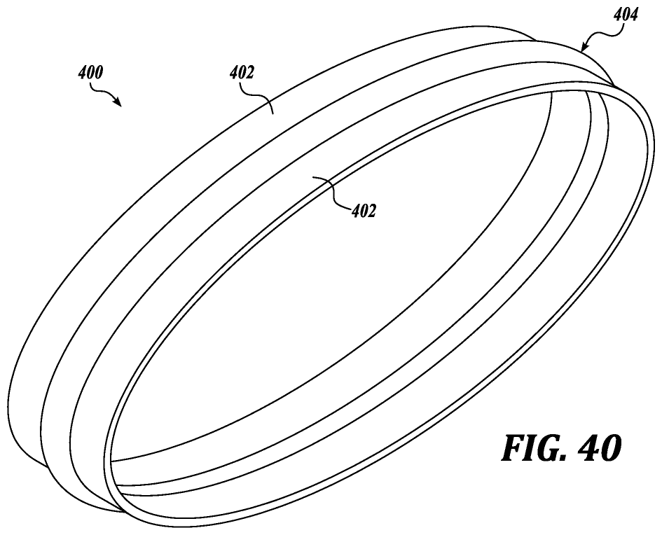

FIGS. 39A and 39B illustrate double boot tap 406 of elliptical cross-section as shown in FIG. 39B. As illustrated, the boot tap includes a main section 408 which is intersected by taps 410 through the use of flared connector sections 412. A cap 414 can be provided to close off the end of the main section 408, if desired. As in the other connectors described above, the connector 406 can be defined by a flat pattern that can be cut from flat stock in then formed and assembled together to produce the shape of the connector shown in FIGS. 39A and 39B. The flat pattern can be welded or otherwise fastened together to achieve the shape of the double boot tap 406.

FIG. 40 depicts a standing seam slip joint 400 of an elliptical cross-section for use in joining elliptically-shaped duct or pipe sections in end-to-end relationship. The slip joint 400 includes first and second insertion portions 402 separated by a standing seam 404 that extends transversely outwardly from the insertion portions to at least the outer surface of the ducting/piping being connected, and preferably some height beyond such outer surface.

The slip joint 400 can be constructed from numerous methods, for example, the slip joint can be formed in circular shape by roll forming a circular band to create the standing seam. Alternatively, the standing seam 404 can be formed in a circular band by using an expansion die. Such circular slip joint can then be formed into a desired elliptical shape using the methodologies discussed above for forming elliptically shaped ducting and piping.

Alternatively, the standing seam 404 can be formed into a longitudinal strip and then the strip stretched around an elliptical die, and thereafter the ends welded or otherwise connected together. The standing seam can be formed into the longitudinal strip by numerous means, including by roll forming or pressing.

The standing seam slip joint connector 400 can be made from materials other than typical HVAC ducting material, for example the connector can be composed of fiberglass, thermoplastics, or fiber reinforced thermoplastics. In this case, the connector 400 can be constructed by injection molding techniques. Alternatively, the cross-sectional profile of the standing seam connector can be extruded into lengths and then the lengths extended around a die form the desired elliptical shape for the connector.

While illustrative embodiments have been illustrated and described, it will be appreciated that various changes can be made therein without departing from the spirit and scope of the invention. For example, although the fittings shown in FIGS. 29A to 39B have been described as constructed from flat patterns of ducting materials that have been cut and shaped into a desired form and then welded, such fittings can be made by other techniques, especially if the fittings are made from other types of material, including fiberglass, thermoplastics, or fiber reinforced thermoplastics. In this regard, the fittings can be injection molded into the shapes shown in the above figures. Such injection molded fittings will be economical to manufacture and be of lightweight and of high strength. Such fittings can be used in conjunction with elliptical-shaped ducting made from metallic materials or from fiberglass, thermoplastics, or fiber reinforced thermoplastics.

As a further example, the elliptical ducting and associated flanged connectors and fittings, as well as the reinforced flanged connectors described above, can be utilized in constructing double-walled HVAC and other types of ducting and associated flanged connectors and fittings. Such double-walled HVAC ducting systems can be of the type disclosed in U.S. Pat. No. 10,539,337, owned by applicant herein and incorporated herein by reference.

As another example, the flange connectors can be integrally formed on the ends of the lengths of elliptical ducting. One option in this regard is to utilize a vee-shaped expander to form the end of the ducting in an outwardly extending vee-shaped section and then continuing the formation of the connector by further forming the vee-shaped section into a mating flange action and a return section that is doubled over the mating flange section to for reinforcement.

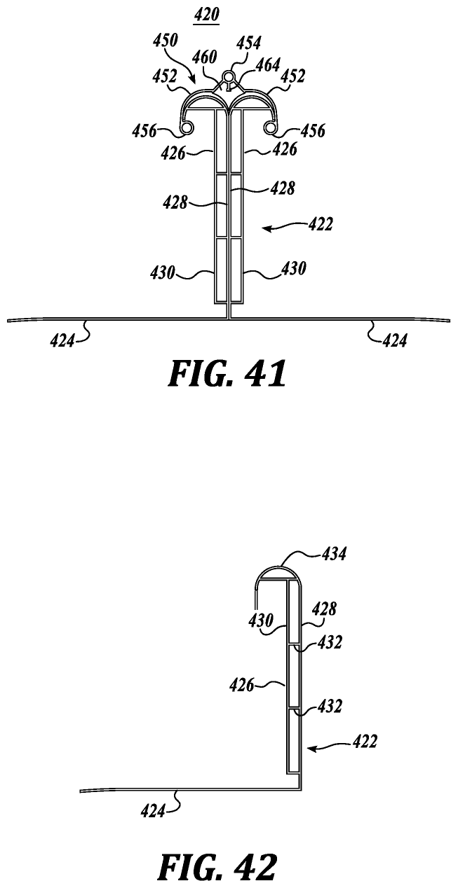

As a further example, FIGS. 41, 42, 43, 44, and 45 illustrate an exemplary embodiment of a cross-sectional profile of a flange connector system 420 that can be produced by extruding the profile using an extrusion die. As shown in these figures, the flange connector system 420 includes an extruded flange structure 422 consisting of an insertion section 424 and the double-wall face section 426 consisting of a mating face 428 and a rearward reinforcing wall 430 spaced slightly rearwardly from the mating face 428 by a series of radially spaced apart spacer sections 432. The circumferentially outward portion of the mating face 428 is rounded to present the curved nose 434 to the exterior of the connector flange structure 422. An upper brace 436 extends transversely to the upper outer end of the reinforcing wall 432 span between sections of the nose 434.

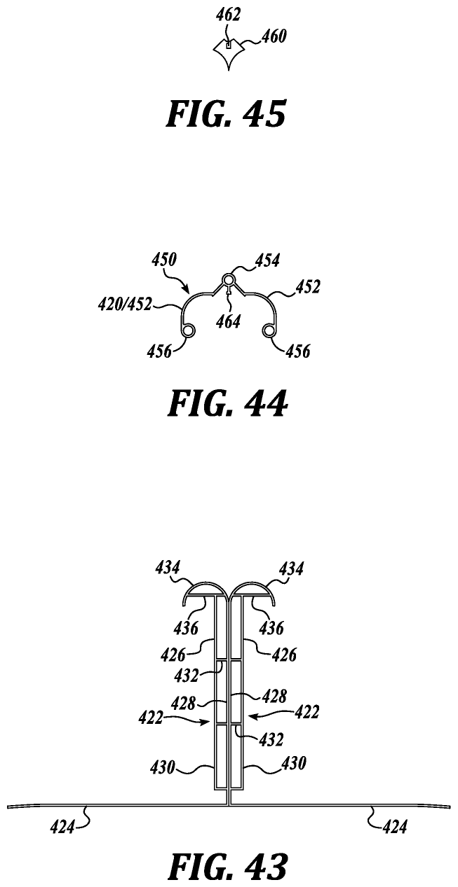

FIG. 43 illustrates two extruded connector flange structures 422 positioned in face-to-face relationship to each other. FIG. 41 illustrates the face-to-face connector flange structures locked together with a closure band 450 in the form of two arcuate sections 452 interconnected by the central outwardly extending, generally circular section 454. The distal ends of the arcuate sections 452 are rounded at 456 so as to slide over the exterior of the nose portions 434 of the connector flange structures 422 and then lock against the connector flange structures to prevent release of the closure band 450.

In addition, a generally diamond-shaped resilient seal 460 includes an upper slot 462 for receiving a tab 464 projecting from the central circular section 454. The seal 460 is shaped to correspond to the arcuate shape of the curved nose section 434, thereby to establish a substantially air-tight seal between the two connector flange structures 422.

The material used can be typical HVAC ducting material, or could be a softer material, such as aluminum. Once extruded into desired lengths, the lengths can be formed in an elliptical shape using the techniques noted above, such as roll forming or wrapping around an oval die, or by other techniques. It can be appreciated that by use of an extrusion, the cross-sectional profile produced can be of innumerable shapes, including, but not limited to shapes having integral reinforcing members or internal cavities or pockets.

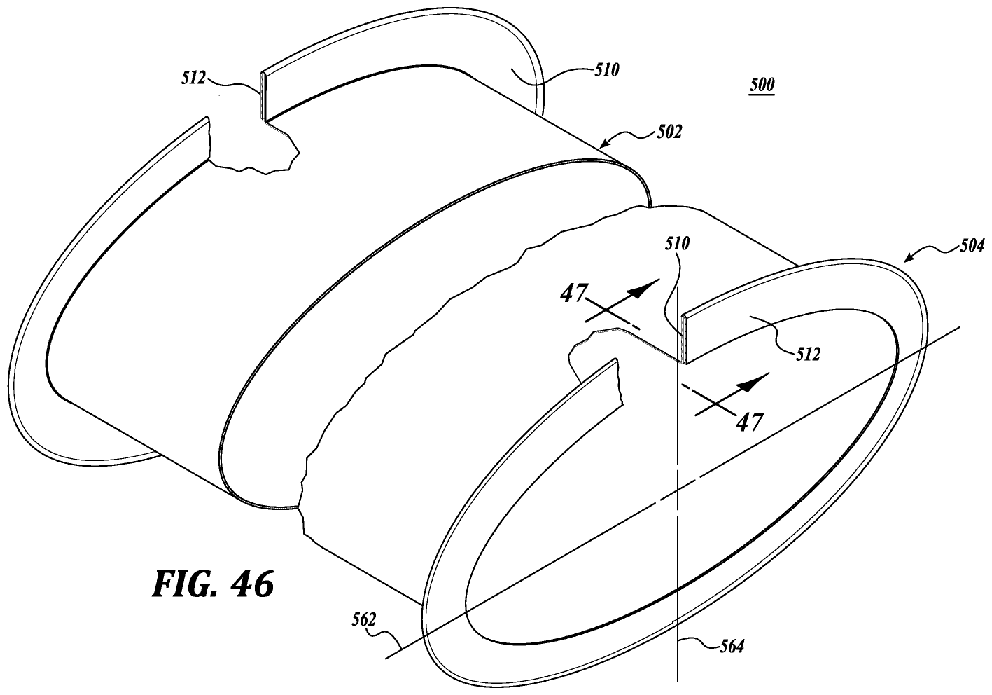

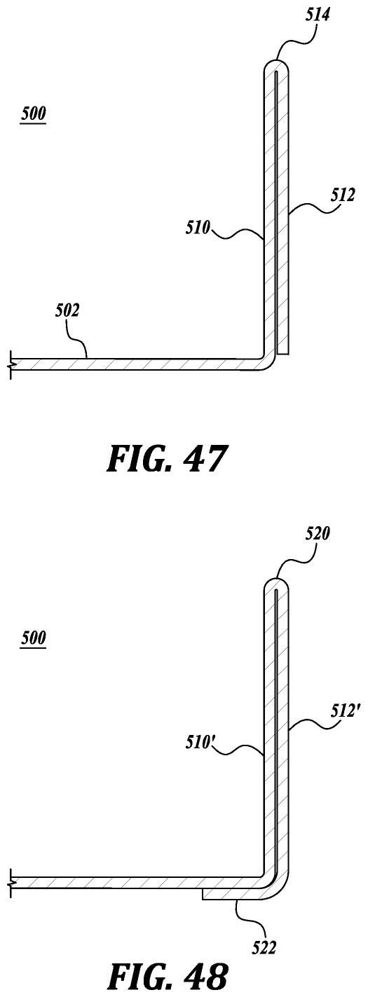

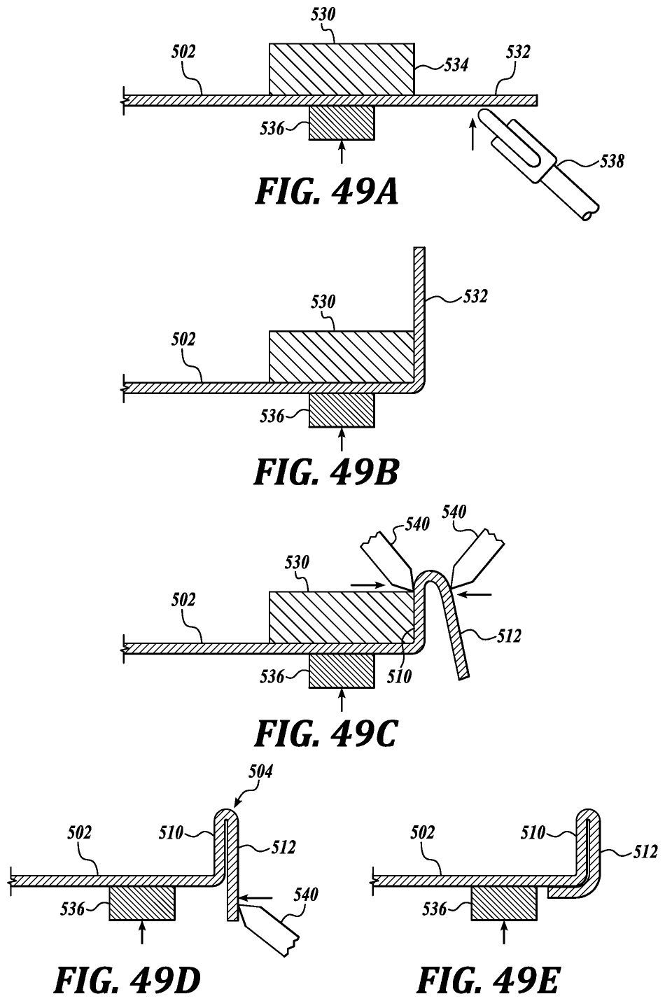

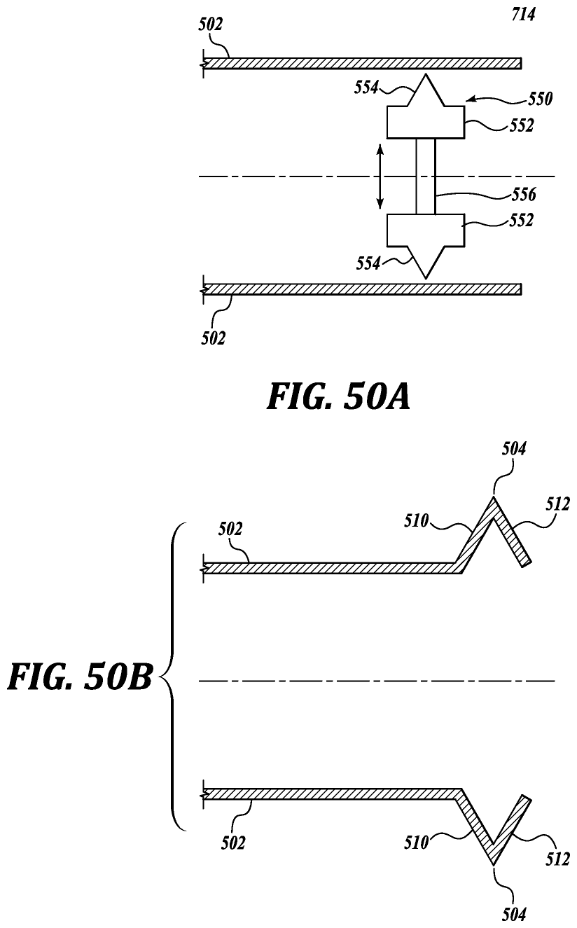

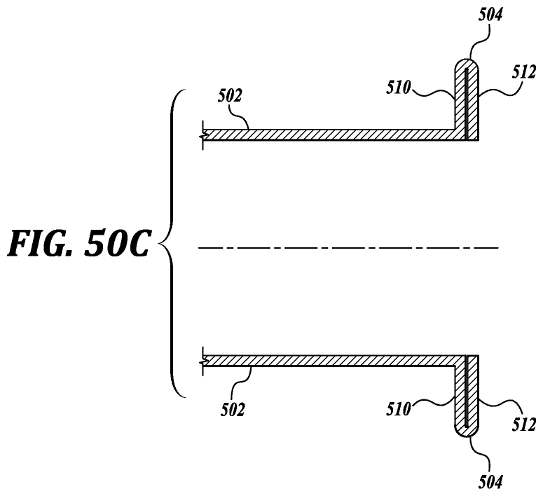

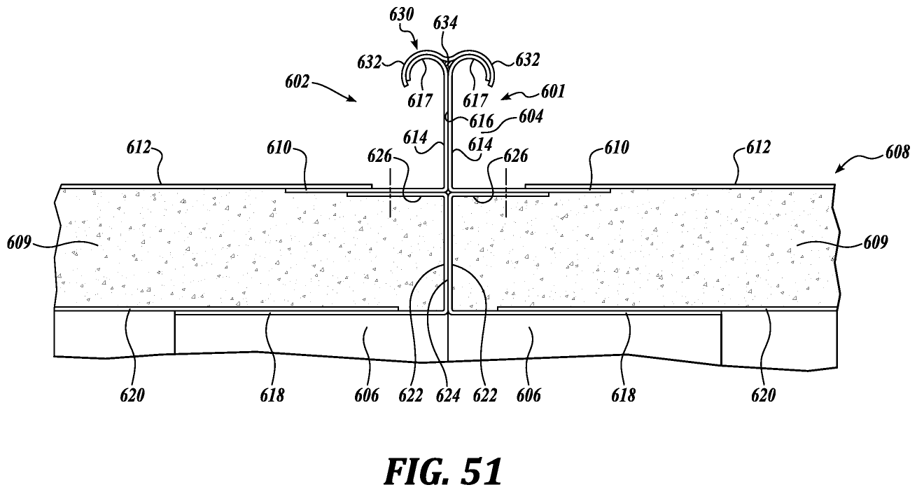

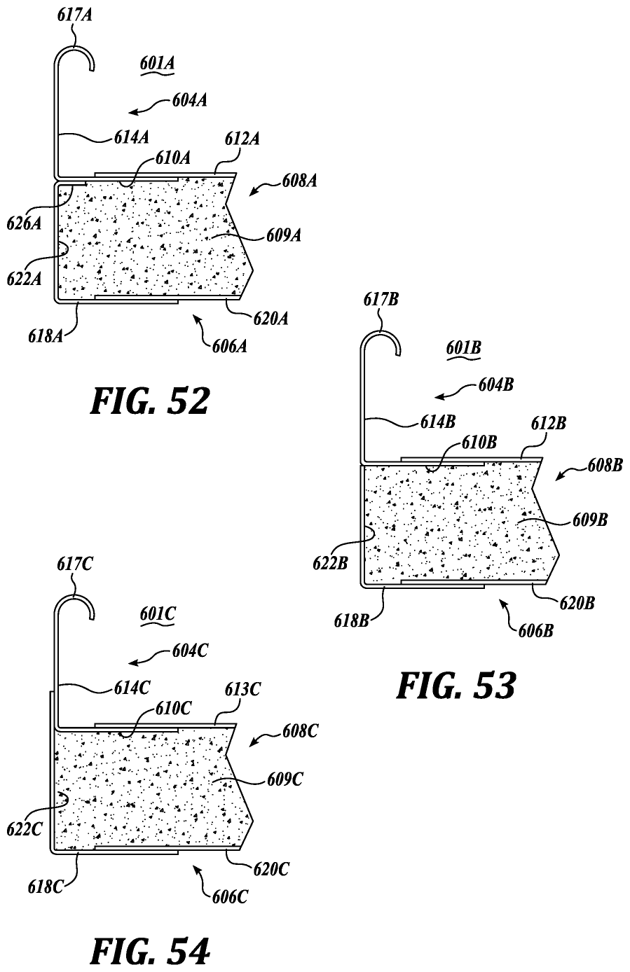

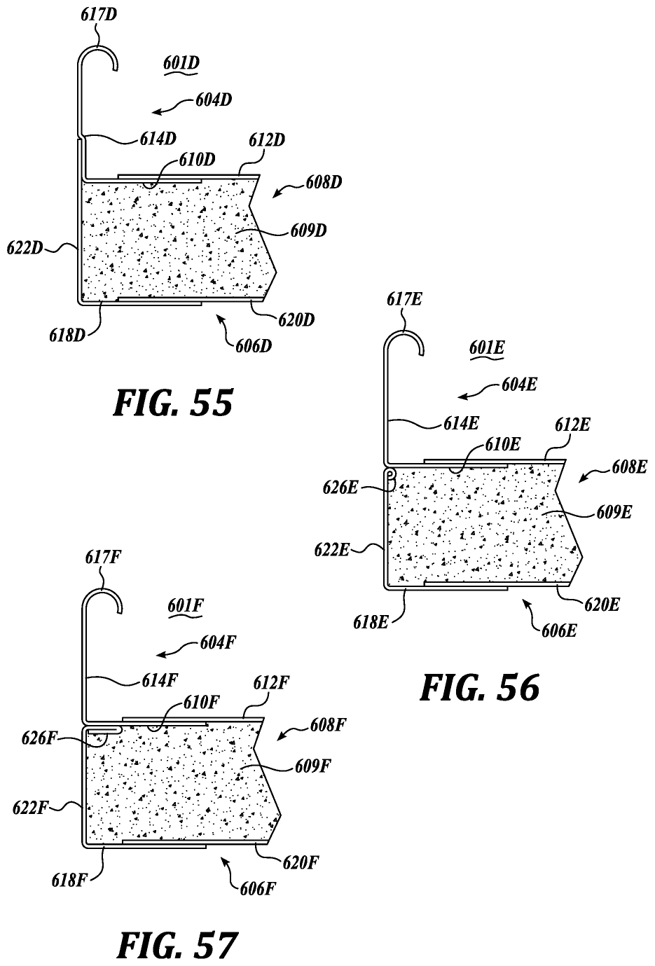

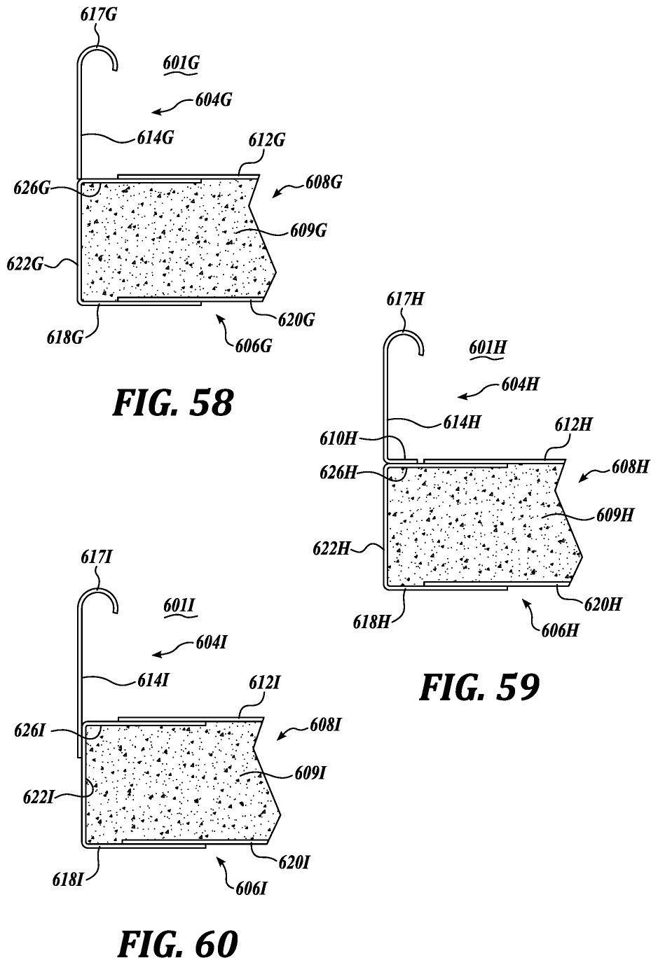

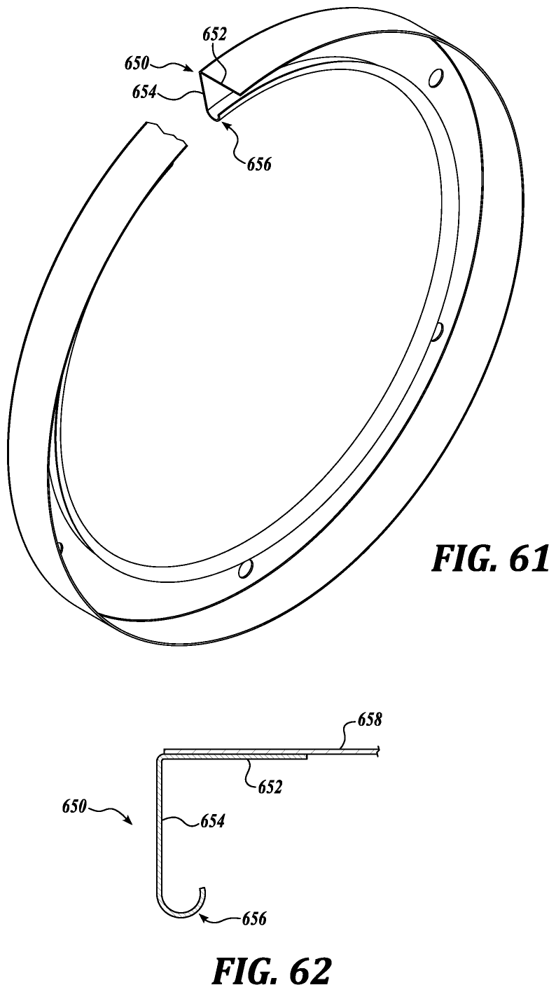

As a further example, FIGS. 46 and 47 illustrate a ducting system 500 in accordance with an embodiment of the present disclosure. The ducting system 500 includes an elongate duct section or length 502 and integrally formed flange connectors 504 at each end of the duct. Both the duct section 502 and flange connectors 504 are elliptical in cross-section, defined by a major axis 506 and a minor axis 508. As in the duct system 50, in the duct system 500, the elliptical cross-section of the duct 502 also has the advantage of reducing the overall height of the duct system along minor axis 506, as well as defining a rigid structure due to there being no flat surface about the circumference of the duct 502, while also capable of transporting a significant volume of air relative to a circular duct system of the same perimeter size. Also, as in duct system 500, the aspect ratio (height to width) of the duct 502 can vary so as to meet specific height restrictions for the duct.

The flange connectors 504 includes a first flange section 510 extending transversely outwardly from the outer end of the duct 502 and the second flange section 512 doubled over the first flange section 510 extend transversely outwardly back toward the duct 502. The second flange section 512 forms the mating face to the flange connector of an adjacent duct 500. The flange connector 504 can be integrally formed at the ends of duct sections 502 by numerous techniques, including by spin forming, expansion forming, roll forming, or a combination thereof, using at least some of the techniques described above, as well as described below.

FIG. 48 illustrates a flange connector 520 that is similar to flange connector 504, but which also includes a return flange portion 522 that extends from the inward edge of the flange second section 512′ longitudinally along the length of the duct 502 and within the inside of the duct 502 to overlap the inner surface of the duct file to. This construction enhances the strength of the flange connector 520.

FIGS. 49A-49E illustrate one representative method of forming the flange connector 504 at the ends of elliptical duct 502 before the duct 502 is converted into elliptical shape from round. In this regard, the duct 502 is placed within a spin die 530 with an end portion 532 projecting from the end face 534 of the die. The duct 502 is held securely within the die 530 by a holding device 536. The die 530, with the duct 502 secured therein, is spun and a forming tool 538 is used to press the projecting end portion 532 against the die face 534 so as to achieve the configuration shown in FIG. 49B.

Referring to FIG. 49C, the turned out end portion 532 is further formed while the duct 502 is spinning within the die 530 using tools 540. The tools 540 press against the end portion to create the first and second sections 510 and 512 of the flange connector so that the second section 512 is doubled over, and in face-to-face contact with the first section 510, as shown in FIG. 49D. As shown in FIG. 49D, a radially inwardly portion of the second section 512 extends within the interior of the duct 502. The tool 540 is pressed against this extension portion to fold the extension portion against the inside surface of the duct 502 thereby to form the return portion 522 of the flange connector 504, as shown in FIG. 49E.

FIGS. 50A-50C disclose another representative method of forming the flange connector 504 at the ends of elliptical duct 502. In this regard, an expander mechanism 550 is used, as schematically shown in FIG. 50A. The expander mechanism 550 includes a plurality of expansion segments 552 having protrusions 554 of a desired size and shape. An expansion actuator 556 (e. g., a pneumatic or hydraulic press) pushes the expansion segments 554 uniformly radially outwardly to press against the interior surface of the duct 502 to push the duct wall outwardly into the shape shown in FIG. 50B. In this regard, the connector first and second sections 510 and 512 have been partially formed. The completed flange connector 504 can be achieved by further working the partially completed connector shown in FIG. 50B by various techniques, including by spin forming, pressing, rolling, etc. so as to achieve the configuration shown in FIG. 50C.

FIG. 51 illustrates double wall flanged connectors 601 and 602 constructed in accordance with the present disclosure. As shown, the connectors 601 and 602 consist of a first larger elliptical flanged ring portion 604 and a second smaller elliptical flanged ring portion 606 fastened together to form an elliptical double wall flanged connector 601 and 602. The flanged connectors 601 and 602 are then attached to double wall elliptical duct 608.

The elliptical duct 608 can be constructed in the manner of the other elliptical ducts described and illustrated herein. The elliptical annular gap between the walls 612 and 620 of the double wall duct can be filled with thermal and/or sound insulating material 609.

The flanged connectors 601 and 602 are created by the joining of a first outer or larger elliptical flanged portion 604 and a second inner or smaller elliptical flanged portion 606. The first flanged connector portion 604 may be composed of, for example, ten gauge or greater metallic material of an elliptical cross-section consisting of the following:
(a) an outer insertion flange section 610 that is of a sufficient length to connect to the outer wall 612 of an elliptical double wall duct 608.
(b) an outer mating flange portion 614 that extends approximately 90° from the outer insertion flange 610. The outer mating flange section 614 defines the first mating face 616 that contacts the corresponding mating face of the adjacent flange connector.
(c) an outer reinforcing seat 617 that curves outwardly from the outer perimeter of the outer mating flange section 614. The outer reinforcing seat 617 is in the shape of a portion of a circle, but can be of other shapes, for example as shown in FIGS. 5-14 herein.

The second flanged ring portion 606 may also be composed of, for example, ten gauge or greater metallic material of elliptical cross-section consisting of the following:
(a) an inner insertion flange 618 that is of sufficient length to connect to the inner wall 620 of the double wall elliptical duct 608.
(b) inner mating flange 622 that extends approximately 90° from the insertion flange section 618. The inner mating flange section 622 defines second mating face 624 that contracts the corresponding mating face 624 of the adjacent flange connector.
(c) an inner hem 626 that extends from the inner mating flange section 622 in the same direction as the inner insertion flange section 618. The inner hem section 626 extends from the inner mating face 622 of sufficient distance to allow secure connection to the first or outer elliptical flanged ring portion 604.

The flanged ring connector 601, 602 is completed when the outer flange ring portion 604 is attached to the inner flanged ring portion 606. The outer flanged ring portion 604 is aligned with the inner flanged ring portion 606 so that the outer mating flange section 614 and the inner mating flange section 622 form a substantially singular plane. The connection may be accomplished by welding, but is not restricted to that method of fastening.

Two sections of double wall ducting 608 may now be connected. The outer insertion flange section 610 is attached to the inner diameter of the outer wall 612 of the elliptical double wall duct 608. The inner insertion flange section 618 is attached to the inner elliptical wall 620 of the double wall duct 608. The two opposing elliptical flange connectors 601, 602 are attached with a closure band assembly 630 that may be similar to the assembly 220 described above. The closure band assembly 630 includes a band portion 632 similar to band portion 222, and a seal 634 that may be similar to seal 224 described above.

FIGS. 52-57 illustrate alternative embodiments of double wall flange connectors for inter-connecting elliptical ducting. The embodiments of FIGS. 52-57 are similar to that shown in FIG. 51, but with different configurations for the inner flanged connector portion. Accordingly, the embodiments of FIGS. 52-57 are designated with part numbers corresponding to FIG. 51, but with the addition of an alphabetic suffix A-F.

The embodiment of the present invention shown in FIG. 52 is similar to that as shown in FIG. 51, but with the inner hem portion 626A shown as being substantially shorter than corresponding hem 626 shown in FIG. 51. The embodiment of the present invention shown in FIG. 53 differs from FIG. 51 in that the inner flange portion 606 does not include an inner hem section. The embodiment in FIG. 54 is similar to that of FIG. 51, but with the inner mating flange 622C overlapping the outer mating flange 614C. The embodiment of FIG. 55 is similar to that of FIG. 54, but with the outer mating flange portion 614D offset to receive the inner mating flange section 622D. The embodiment of the present invention shown in FIG. 56 illustrates the hem section 626E configured as a circular bead. The embodiment of the present invention shown in FIG. 57 includes a return hem section 626.

Further embodiments to the present invention are listed in FIGS. 58-60. The double wall flanged connectors shown in these figures are similar to that shown in FIG. 51, but with the outer flange connector portion being of various configurations. These embodiments are designated with part numbers corresponding to FIG. 51 but with an alphabetic suffix G-I. As in the embodiment of present invention FIG. 51, the embodiments shown in FIGS. 58-60 may also be constructed according to the methods described herein.

The embodiment of the present invention shown in FIG. 58 is similar to the embodiment of the present invention shown in FIG. 51, but without utilizing an outer insertion flange section. FIG. 59 depicts an embodiment of the present invention that is similar to FIG. 51, but with the insertion flange 610H being rather short so as not to overlap the outer duct 612H, rather the inner hem 626H is attached to the outer duct 612H. The embodiment of the present invention shown in FIG. 60 does not utilize an outer insertion flange, rather the outer mating face 6141 overlaps the inner mating face 6221.

FIGS. 61 and 62 illustrate a further embodiment of the present disclosure wherein an angle ring 650 is constructed with a “J” shape reinforcing seat or curl 656 formed along the outer perimeter of the mating flange 654. A reinforcing member can be captured in the reinforcing seat 656 in the manner of the flanged connectors described herein.

In FIG. 62, the angle ring 650 shown is attached to the end of duct wall 658. In this regard, the insertion/portion 652 extends along the interior of the duct wall 658. As an alternative, the insertion flange 652 can extend along the exterior side of the duct wall 658. The duct 658 may be elliptical cross-section, or may be of other cross-sectional shapes, for example, such as round or round oval.

The angle ring 650 in dimensions can correspond to ASTM standards, or can be of other dimensions. In this regard, in thickness the angle ring 650 may be of lighter gauge than required for standard angle rings due to the additional structural integrity and stiffness provided by the “J” reinforcing seat/curl 656.

The angle rings 650 may be joined together in various ways. For example, bolts or other types of hardware members may extend through openings formed in the mating flange 654, which is a standard method for attaching angle rings together. However, as an alternative due to the existence of the “J” shaped curl/seat 656, a closure band, similar to band 630, can be used to secure the face-to-face angle rings securely together.

The angle ring 650 may be manufactured by various techniques, such as by extrusion. In this regard, the extrusion can be of the cross-section shown in FIG. 62, and then the longitudinal extruded section mating formed into a round cross-section by roll forming or other techniques. Thereafter, the round cross-section can be formed into an elliptical cross-section by pressing or other techniques as discussed herein.

1. A HVAC duct system comprising an elongate duct consisting of a metallic substrate formed into an elliptical cross-sectional shape having an aspect ratio of from 1:1.1 to 1:4 along the entire length of the elongate duct.

2. The HVAC duct system according to claim 1, wherein flange connectors are formed on one or both ends of the duct, wherein the flange connectors have mating flange portions extending transversely to a length of the duct, the flange connectors having an elliptical cross-sectional shape corresponding to the cross-sectional shape of the duct.

3. The HVAC duct system according to claim 2, wherein the mating flange portions comprising an outer perimeter, and a formed reinforcing seat extending along the outer perimeter of the mating flange portions, the reinforcing seat projecting laterally from the plane of the mating flange in the direction toward an opposite end of the HVAC ducting.

4-5. (canceled)

6. The HVAC duct system according to claim 3, further comprising a reinforcing member tightly disposed within the reinforcing seat.

7. The HVAC duct system according to claim 6, wherein the reinforcing member is shaped to corresponds to the shape of the reinforcing seat.

8-9. (canceled)

10. The HVAC duct system according to claim 2, further comprising a closure band extending around the outer perimeter of flange connectors at adjacent ends of HVAC ducting for retaining the flange connectors in face-to-face relationship to each other.

11-14. (canceled)

15. The HVAC duct system according to claim 1, further comprising one or more fittings for connection to the elliptical cross-sectional duct selected from the group consisting of: elbows; taps; lateral taps; angle taps; boot taps; T-fittings; reducers; dampers; slip connectors; offset connectors.

16. The HVAC ducting system according to claim 2, wherein the mating flange portion comprising a first section extending transversely outwardly from the end of the duct and a second section doubled over the first section to extend transversely outwardly toward the duct to form a mating face to the flange connector of an adjacent duct.

17. The HVAC ducting system according to claim 16:
where in the second section of the mating flange portion defining an inner perimeter; and
further comprising a return section extending from the inner perimeter of the second section of the mating flange toward the duct.

18. (canceled)

19. The HVAC ducting system according to claim 17, wherein the return section closely overlying the inside surface of the duct.

20. The HVAC ducting system according to claim 1, wherein the substrate is composed of spiral lock seam ducting, longitudinal lock seam ducting or longitudinal welded seam ducting.

21. A flange ring connector to join ducts in an HVAC system, wherein the ducts are elliptical in cross section along their entire lengths, the flanged ring connector comprising:
(a) a mating flange defining a mating face, the mating flange defining an outer perimeter portion and an inner perimeter portion, and the mating flange being of an elliptical shape corresponding to the elliptical cross-sectional shape of the HVAC ducts;
(b) an insertion flange extending laterally from the inner perimeter portion of the mating flange, the insertion flange having an inside surface and an outside surface, the insertion flange in cross-section closely corresponding to the elliptical cross-sectional shape of the HVAC ducts, and the insertion flange having a sufficient length to allow fixed attachment to the elliptically-shaped HVAC ducting; and
(c) a formed reinforcing seat extending around the perimeter of the mating flange and projecting laterally from the mating flange in the direction that the insertion flange extends from the mating flange.

22. (canceled)

23. The flanged ring connector according to claim 21, wherein the cross-sectional size of the reinforcement seat may vary in size in accordance with the desired increase in structural integrity of the flanged ring connector.

24. (canceled)

25. The flanged ring connector according claim 21, wherein the mating and insertion flanges comprise an angle ring configuration.

26. The flanged ring connector according to claim 21, further comprising a reinforcing member disposed within the reinforcing seat to increase the structural integrity of the flanged ring connector.

27-28. (canceled)

29. The flanged ring connector according to claim 21, further comprising a closure band extending around the outer perimeter of flange connectors at adjacent ends of HVAC ducting for retaining the flange connectors in face-to-face relationship to each other.

30-31. (canceled)

32. A flange ring connector to join ducts in an HVAC system, comprising:
(a) a mating flange defining a mating face, the mating flange defining an outer perimeter portion and an inner perimeter portion, and the mating flange being of a shape corresponding to the cross-sectional shape of the HVAC ducting;
(b) an insertion flange extending laterally from the inner perimeter portion of the mating flange, the insertion flange having an inside surface and an outside surface, the insertion flange in cross-section closely corresponding to the cross-sectional shape of the HVAC ducts, and the insertion flange having a sufficient length to allow fixed attachment to the HVAC ducts; and
(c) a formed reinforcing seat extending around and integrally formed with the perimeter of the mating flange, the reinforcing seat projecting laterally from the outer perimeter portion of the mating flange in the direction that the insertion flange extends from the mating flange and then projecting in the direction towards the insertion flange.

33. (canceled)

34. The flanged ring connector according to claim 32, wherein the reinforcing seat is of a cross-sectional shape selected from the group consisting of square, polygonal, oblong, rectangular, circular, partially circular, quarter-circular, semicircular, elliptical, oval, triangular, frusto-triangular, vee-shaped, arcuate, and tubular.

35. The flanged ring connector according to claim 32, further comprising a reinforcing member disposed within the reinforcing seat to increase the structural integrity of the flanged ring connector.

36-37. (canceled)

38. The flanged ring connector according to claim 32, further comprising a closure band extending around the outer perimeter of flange connectors at adjacent ends of HVAC ducting for retaining the flange connectors in face-to-face relationship to each other.

39. (canceled)

40. An architectural feature of an elliptical cross-sectional shape constructed by forming flat stock into an elliptical cross-section with the edges of the flat stock in close side-by-side relationship to each other to define a seam and by closing the seam.

41. (canceled)

42. The architectural feature of claim 40, selected from the group consisting of railings, hanging rods, hanging bars, brackets, stanchions, and legs.
